(19) United States
(12) Patent Application Publication
(10) Pub. No.: US 2026/0004518 A1
(43) Pub. Date: Jan. 1, 2026

(54) THREE-DIMENSIONAL RECONSTRUCTION OF OBJECTS USING DEPTH MAPS

(71) Applicant: Fitasy Inc.

(72) Inventors: Yujun Wang, Carmel, IN (US); Jian Gong, Carmel, IN (US); Carl Justin Kamp, Carmel, IN (US)

(21) Appl. No.: 19/242,853

(22) Filed: Jun. 18, 2025

Related U.S. Application Data
(60) Provisional application No. 63/665,779, filed on Jun. 28, 2024.

(51) Int. Cl. G06T 17/00; B29C 64/386; B33Y 50/00; G06T 7/50

(52) U.S. Cl. CPC G06T 17/00; B29C 64/386; B33Y 50/00; G06T 7/50; G06T 2200/04; G06T 2200/08; G06T 2207/10028; G06T 2207/30168; G06T 2207/30196; G06T 2210/12

(57) ABSTRACT

Methods, systems, and apparatus, including computer programs encoded on a computer storage medium, for reconstructing three-dimensional (3D) objects using depth scans. In one aspect, a method of generating a 3D reconstruction of an object includes obtaining, for each view in a set of views of the object, a quality depth map that represents location coordinates of points on the object from the view, wherein the obtaining comprises. For each view, image data representing one or more images of the object from the view are obtained and one or more depth maps that represent location coordinates of points on the object are obtained. A quality depth map that satisfies one or more quality checks is identified for each view. The 3D reconstruction of the object is generated using the quality depth map for each view in the set of views.

### CROSS-REFERENCE TO RELATED APPLICATION

This application claims priority to U.S. Provisional Patent Application No. 63/665,779, filed on Jun. 28, 2024, which is incorporated by reference into this application in its entirety and for all purposes.

### TECHNICAL FIELD

This specification relates to computer vision, computer graphics, virtual reality, and three-dimensional reconstruction of objects using depth scans.

### BACKGROUND

Three-dimensional (3D) reconstruction is an area of computer vision and computer graphics directed to generating three-dimensional representations of objects or scenes.

### SUMMARY

In general, one innovative aspect of the subject matter described in this specification can be embodied in methods that include the actions of obtaining, for each view in a set of views of the object, a quality depth map that represents location coordinates of points on the object from the view, wherein the obtaining includes, for each view, obtaining image data representing one or more images of the object from the view, obtaining one or more depth maps that represent location coordinates of points on the object, and identifying, as the quality depth map, a given depth map that satisfies one or more quality checks; generating the 3D reconstruction of the object using the quality depth map for each view in the set of views; and outputting the 3D representation of the object. Other implementations of this aspect include corresponding apparatus, systems, and computer programs, configured to perform the aspects of the methods, encoded on computer storage devices.

These and other embodiments can each optionally include one or more of the following features. In some aspects, outputting the 3D representation of the object includes displaying the 3D representation of the object.

In some aspects, the object includes a foot. Outputting the 3D representation of the model can include sending the 3D representation of the model to an additive manufacturing device configured to generate a form of the foot using the 3D representation of the object.

In some aspects, the image data includes a digital image of the object and depth data that indicates, for each pixel in the digital image, a distance between a camera that captured the digital image and the object depicted by the pixel.

In some aspects, obtaining the image data includes obtaining the image data from two or more cameras having different optical axes.

In some aspects, obtaining the image data includes obtaining the image data from a depth sensor and/or a LiDAR camera.

In some aspects, identifying, as the quality depth map, a given depth map that satisfies one or more quality checks includes performing the one or more quality checks using the given depth map. Performing the one or more quality checks can include determining whether a distance between the object and a scanning device that captured at least a portion of the image data is within a target range. Performing the one or more quality checks can include determining whether an angle between the object and a scanning device is within a target range. Performing the one or more quality checks can include determining whether the object is located within a bounding box. Performing the one or more quality checks can include determining that the depth map did not pass a quality check and, in response to determining that the depth map did not pass the quality check, providing a voice guide that audibly instructs a user to realign the object with a scanning device.

In some aspects, the object is an asymmetric object. In some aspects, the object is a hand.

Some aspects include analyzing the 3D reconstruction of the object to identify dimensions and/or geometries of the object.

Some aspects include presenting an interactive user interface that depicts a scan diagram that shows a user how to properly align the scanning device with the object.

Some aspects include guiding the user through a sequence of interactive user interfaces to capture image data for each view. The sequence of user interfaces includes, for each view, an interactive user interface that depicts a scan diagram for the view. The scan diagram for each view shows a user how to properly align the scanning device with the object for that view. Each scan diagram can depict a target distance or target distance range from which the scanning device should be spaced from the object. Some aspects include, for each view, performing the one or more quality checks on each of one or more depth maps obtained using the user interface for the view to identify the given depth map that satisfies the one or more quality checks for the view. Generating the 3D reconstruction of the object using the quality depth map for each view in the set of views can include generating the 3D reconstruction in response to identifying the quality depth map for each view.

In some aspects, obtaining the one or more depth maps that represent location coordinates of points on the object comprises obtaining a depth map using optical image data from the one or more images of the object and depth data obtained from a depth sensor.

Some aspects include executing multiple processing threads. A first processing thread of the multiple processing threads can be executed to obtain the quality depth map for each view. A second processing thread of the multiple processing threads can be executed to generate the 3D reconstruction of the object. In some aspects, the multiple processing threads include a third processing thread that calculates metrics for quality depth maps when the quality depth maps are obtained. Some aspects include automatically initiating the third thread to calculate metrics for a quality depth map in response to obtaining the quality depth map. Some aspects include automatically constructing a portion of the 3D reconstruction by combining two quality depth maps for two different views in the second thread in response to the metrics for the two quality depth maps being calculated in the third thread.

Particular embodiments of the subject matter described in this specification can be implemented so as to realize one or more of the following advantages. The techniques described in this document enable accurate three-dimensional (3D) reconstruction of objects, including asymmetric objects, such that accurate dimensions of the objects can be obtained and/or the reconstructions can be used, e.g., directly, to create other objects, e.g., shoes that properly fit a person's foot that is represented by the 3D reconstruction or gloves that fit a person's hand that is represented by the 3D reconstruction. The techniques enable such accurate reconstructions efficiently using still images rather than continuous scanning such that the techniques can be used when continuous scanning is impossible or impractical, e.g., when a person is capturing scans of their own feet including the bottom of their feet. The described techniques also use fewer images than continuous scanning techniques (e.g., simultaneous localization and mapping (SLAM)) that involve a larger number of images. Using fewer images in this way results in faster and more efficient reconstructions without sacrificing accuracy, and uses less memory to store the images as well as fewer computational resources (e.g., processor cycles) to perform the calculations.

Quality check techniques can be used to ensure that depth maps generated using image data for an object obtained from the still scans are high-quality, which ensures that the 3D reconstructions are accurate. The user interfaces make it easy and convenient for users to capture high quality scans by showing the target area for the placement of the scanning device relative to the object and using voice prompts to adjust the relative location of the scanning device such that the user can find the proper placement in situations where the user cannot view the display of the scanning device.

The use of still images and the described user interfaces improve the ease of use and convenience for the user obtaining the scans. As each scan is standalone, the scanning process is more flexible as the user can repeat scans if necessary (e.g., due to low quality scans) without having to repeat the entire process as would be required in continuous scanning. The combination of the described techniques and user interfaces (e.g., including voice or other audible prompts) enable the collection of higher quality data, which is the key to achieve accurate reconstructions and measurements.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a 3D reconstruction system generates 3D reconstructions of objects.

FIG. 2 a block diagram of an example 3D reconstruction system.

FIG. 3 depicts example scans of a person's foot.

FIG. 4 is a flow chart of an example process for generating a 3D reconstruction of an object.

FIG. 5 is a flow chart of an example process for evaluating the quality of a depth map.

FIG. 6 is a flow chart of an example process for processing a depth map.

FIG. 7 is a flow chart of an example process for generating a 3D reconstruction using depth maps.

FIG. 8 is a flow chart of an example process for generating a 3D reconstruction of an object.

FIG. 9 depicts a scan of a bottom of a foot.

FIG. 10 depicts a target scan zone for generating a depth scan of a bottom of a foot.

FIG. 11 is a flow chart of an example process for performing a quality check on a depth scan of a bottom of a foot.

FIG. 12 depicts a scan of a side of a foot.

FIG. 13 depicts a target scan zone for generating a depth scan of a side of a foot.

FIG. 14 is a flow chart of an example process for performing a quality check on a depth scan of a side of a foot.

FIG. 15 depicts a scan of a front of a foot.

FIG. 16 depicts a scan of a back of a foot.

FIG. 17 is a flow chart of an example process for performing a quality check on a depth scan of a front or back of a foot.

FIG. 18 depicts an example interactive user interface for initiating a scan of a foot.

FIGS. 19A and 19B depict example interactive user interfaces for capturing scans of a bottom of a foot.

FIGS. 20A and 20B depict example interactive user interfaces for capturing scans of an inner side of a foot.

FIGS. 21A and 21B depict example interactive user interfaces for capturing scans of an outer side of a foot.

FIGS. 22A and 22B depict example interactive user interfaces for capturing scans of a front of a foot.

FIGS. 23A and 23B depict example interactive user interfaces for capturing scans of a back of a foot.

FIGS. 24A and 24B depict example interactive user interfaces for capturing scans of a top of a foot.

FIG. 25 depicts an example interactive user interface that shows a reconstructed 3D point cloud of a foot.

FIG. 26 depicts an example interactive user interface that shows calculated parameters of a foot using a 3D reconstruction of the foot.

FIG. 27 is a block diagram of an example computer.

Like reference numbers and designations in the various drawings indicate like elements.

### DETAILED DESCRIPTION

This specification describes techniques for effectively, efficiently, and accurately generating, e.g., reconstructing, 3D objects with high accuracy. The techniques can be used to generate 3D reconstructions of symmetric and asymmetric objects. Examples of asymmetric objects include parts or all of a human or animal body (e.g., feet and/or hands), statues, shoes, gloves, trees, plants, etc. The 3D reconstructions can be used for various purposes, e.g., virtual fitting of shoes, gloves, or other apparel, designing customized shoes, gloves, or other apparel, augmented reality (AR) systems (e.g., AR games), additive manufacturing (e.g., of parts for an asymmetric machine or component of a machine), and so on. For example, by comparing a person's foot parameters with a shoe's dimensions, a proper fitting evaluation can be performed and that evaluation can be used to recommend shoes that provide appropriate fitting and comfort. In another example, a 3D reconstruction can be used to create a new shoe using additive manufacturing such that the shoe properly fits the foot represented by the 3D reconstruction.

Obtaining accurate measurements of the objects is important for generating accurate 3D reconstructions of the objects. Recent developments in high-accuracy image capturing technologies, especially on mobile devices, enable the bespoke service through 3D scanning to be practical and affordable for every person. High-accuracy 2D cameras, depth sensors (e.g., depth cameras), and LiDAR on mobile phones can provide millimeter-level accuracy. However, obtaining high-quality and robust digital image data from mobile devices for 3D reconstruction is challenging.

Existing 3D reconstruction techniques, such as simultaneous localization and mapping (SLAM) rely on continuous scanning, which is difficult to use and time consuming, especially for people using mobile devices with complex and changing backgrounds. Continuous scanning requires 360-degree scanning of an object at a certain distance window at a certain scanning speed. The scanning is easy to fail if the mobile device moves too fast or at an unfavorable distance. This is especially difficult, if at all possible, for a person to perform continuous scanning of their own foot considering the various angles around the foot and the distances required between the scanning device and the foot.

The systems and techniques described in this document provide for fast, efficient, accurate, and low-cost 3D scanning of objects to capture high-quality images that can be used to generate accurate 3D reconstructions of the objects without requiring continuous scanning. Instead, depth maps can be generated using discrete images of an object captured from multiple perspectives. For example, depth values can be calculated using the images and/or obtained from image data for the images and the depth maps can be calculated using the depth values. A “depth map” describes, at each pixel of the object, the position (xrw, yrw, zrw) in the real-world coordinates. A depth value represents the distance of an object or point on an object from the camera, e.g., the z value of the point on the object. A depth image represents, for each pixel of the image, the depth value for the pixel.

Quality check techniques described in this document ensure that depth maps generated using image data for an object obtained from the scans are high-quality (e.g., accurate and/or noise free), which ensures that the 3D reconstructions are accurate. The accurate 3D reconstructions can also be used to generate accurate measurements of parameters of objects, e.g., the length, width, girth, cross-sectional area, etc., of a foot or hand or portions thereof (e.g., fingers or toes for ring sizing).

User-friendly interactive user interfaces facilitate the fast and convenient scanning of objects. For example, the interfaces can include voice guides that instruct the user on the proper placement of a scanning device (e.g., mobile device with camera(s)) relative to the object, which is particularly helpful when the user is scanning their own foot and cannot view the display of the scanning device. The voice prompts can alert the user when the scanning device is not properly aligned with the object (e.g., when the camera is not a proper distance from the object and/or when the object is not in a target area for the scan) and/or guide the user to move the scanning device and/or object such that the scanning device is properly aligned with the object.

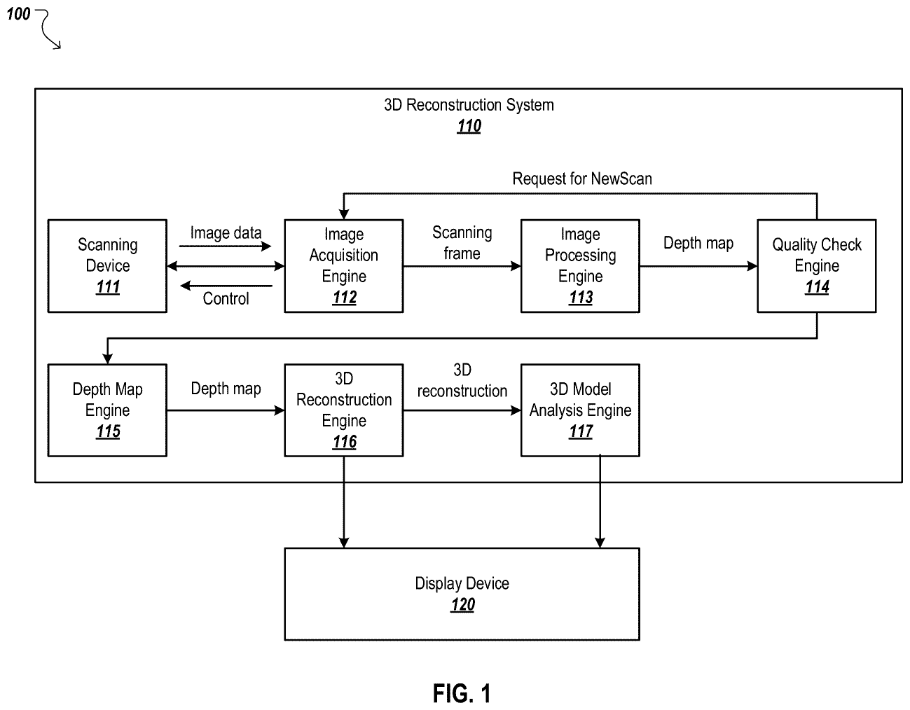

FIG. 1 is a block diagram of an example environment 100 in which a 3D reconstruction system 110 generates 3D reconstructions of objects. The 3D reconstruction system 110 can be configured to generate 3D reconstructions of symmetric and asymmetric objects using discrete scans of the object from various perspectives.

The example 3D reconstruction system 110 includes a scanning device 111, an image acquisition engine 112, an image processing engine 113, a quality check engine 114, a depth map engine 115, a 3D reconstruction engine 116, and a 3D model analysis engine 117. The 3D reconstruction system 110 can also include or be communicatively coupled to a display device 120, e.g., a monitor, television, or screen (e.g., touchscreen) of a mobile device.

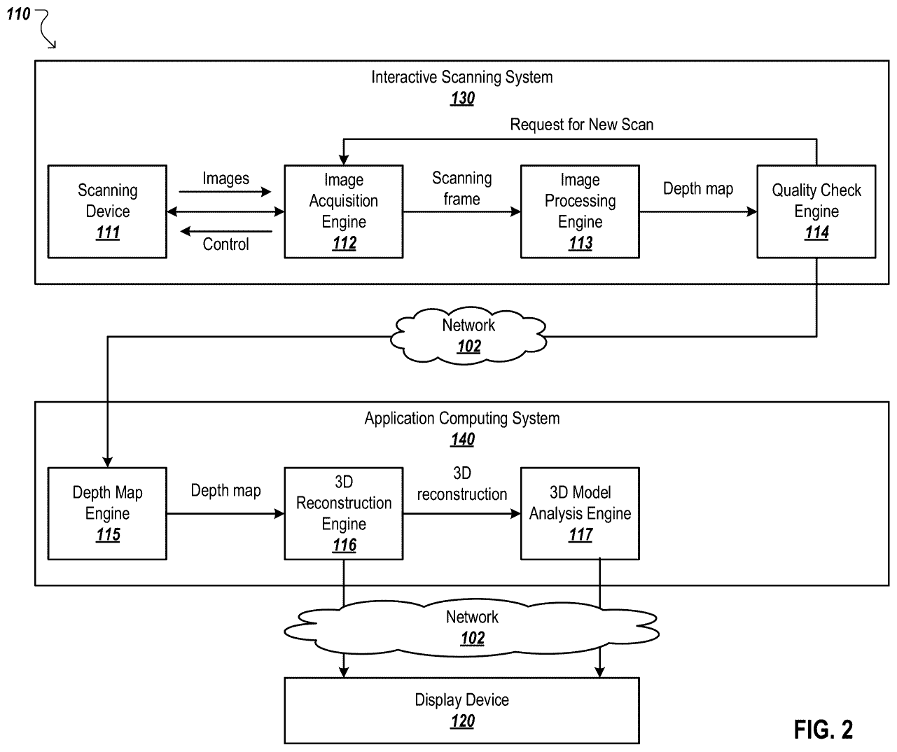

The 3D reconstruction system 110 can be implemented using one or more devices at one or more locations. The device(s) can include one or more computers (e.g., personal computers, servers, or cloud-based computing environments) and/or one or more mobile devices (e.g., smartphones and/or tablet computers). In this example, the 3D reconstruction system 110 is shown as a single device, e.g., a single computer or mobile device. In other examples, the components of the 3D reconstruction system 110 can be divided between multiple devices. FIG. 2 provides an example of a 3D reconstruction system 110 that includes two devices coupled together by a network.

Referring to FIG. 2, an example 3D reconstruction system 110 can include an interactive scanning system 130 and an application computing system 140. For example, the interactive scanning system 130 can be a mobile device that obtains the scans of the object and performs some processing of the scans. The application computing system 140 can be a computer or a cloud-based computing system, e.g., one or more computing devices that are more computationally powerful than the mobile device, that generates the 3D reconstructions using depth maps received from the interactive scanning system 130. In this way, the more computationally intensive processing can be performed by a more computationally powerful computing device, which can increase the speed and efficiency of the 3D reconstruction process. In addition, this enables the use of accurate scanning devices 111 of mobile devices (e.g., relative to a typical computer) to capture the scans of the object.

Although certain components of the 3D reconstruction system 110 are shown as being part of either the interactive scanning system 130 or the application computing system 140, other arrangements of components are possible. For example, the depth map engine 115 can be part of the interactive scanning device 130 rather than the application computing system 140. In another example, the interactive scanning device 130 can only include the scanning device 111 and optionally the image acquisition engine 112, while the other components are part of the application computing system 140.

In the illustrated example, the interactive scanning system 130 includes the components configured to obtain images of the object (also called scans of the object), generate depth maps, and to perform quality checks on the depth maps to ensure that the depth maps are high-quality depth maps from which accurate 3D reconstructions can be generated. In this way, the interactive scanning device 130 can more quickly iterate through images and their corresponding depth maps until high-quality depth maps are generated before sending data to the application computing system 140.

The interactive scanning system 130 is communicative coupled to the application computing system 140 by way of a network 102. The network 102 can include a local area network (LAN), a wide area network (WAN), the Internet, or a combination thereof.

Referring to either FIG. 1 or FIG. 2, the scanning device 111 includes one or more cameras for collecting digital image data from different views of an object. In some implementations, the scanning device 111 includes two RGB cameras that have different optical axes due to their lenses being spaced apart a small distance. This causes objects that are closer to the camera to shift by a greater distance between the two images captured by the two RGB cameras. The depth value for each point on the object in the image can be calculated based on this difference or disparity. The depth value for an object or point on an object refers to the distance from the camera (e.g., the lens of the camera) to the object or point on the object in an image.

In some implementations, the scanning device 111 includes a depth camera (or other appropriate depth sensor) that captures the depth value for each object or point on each object in the field of view of the camera. An example of a depth camera is the True Depth camera that projects an infrared light pattern in front of the camera and images that pattern with an infrared camera. By observing how objects in the scene distort the pattern, the 3D reconstruction system 110 can calculate the distance (or depth) from the camera to each point in the image. The resulting depth data is similar to that produced by a dual-camera device.

In some implementations, the scanning device 111 includes a LiDAR (light detection and ranging) camera that uses light in the form of a pulsed laser to measure distance and depth, which can be used to obtain a depth value of each object or point on an object. Other cameras capable of capturing images that can be used to obtain depth data and/or that capture depth data for objects or points on objects can also be used. In some implementations, the scanning device 111 includes one or more RGB cameras, one or more depth cameras, one or more LiDAR cameras, or any combination thereof. In such cases, the data from the multiple cameras can be compared and/or aggregated to determine the depth values. For example, an average of two depth values captured using two cameras can be used.

The image acquisition engine 112 is configured to control the scanning device 112 to obtain image data from the camera(s) of the scanning device 112. The image data can include, for example, a digital image of a scene (which can include an object to be reconstructed) and depth data. The depth data can be in the form of a depth map or other form that includes depth values for object(s) in the scene and/or depth values for points on the object(s). Each scan of an object can result in a scanning frame that includes a digital image and depth data for the object(s) in the image.

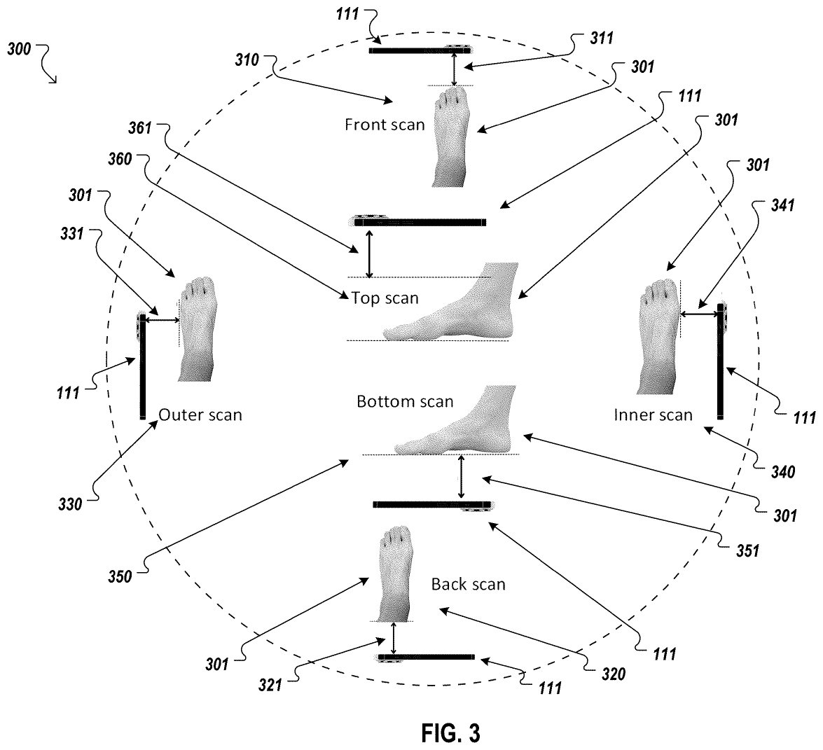

The image acquisition engine 112 can be configured to guide a user to obtain scans of an object from different views or perspectives. For example, the image acquisition engine 112 can be programmed to guide the user to obtain a set of scans for each type of multiple types of objects, e.g., feet, hands, statues, etc. The set of scans can differ for different types of objects. An example set of scans for a foot are shown in FIG. 3 and described below. In some implementations, the image acquisition engine 112 is configured to display interactive user interfaces at the display device 120 to guide the user to obtain the set of scans. The image acquisition engine 112 can also use voice prompts to guide the user to obtain high quality scans, as described in more detail below.

The image acquisition engine 112 can interact with the quality check engine 114. As described in more detail below, the quality check engine 114 is configured to perform a quality check on the data for each scanning frame (e.g., each image and its depth data, which may be represented as a depth map in the quality check). If the quality check is passed successfully, the quality check engine 114 can notify the image acquisition engine 112 and the image acquisition engine 112 can transition to the next view of the object. If the quality check is not passed successfully, the quality check engine 114 can notify the image acquisition engine 112 (e.g., by requesting another scan from the same view) and the image acquisition engine 112 can obtain another scanning frame for the same view of the object. The image acquisition engine 112 and the quality check engine 114 can repeatedly acquire additional scanning frames and perform quality checks for a view until the quality check is passed for at least one of the scanning frames for the view.

The image acquisition engine 112 can send each scanning frame to the image processing engine 113 for processing, e.g., prior to the quality check engine 114 performing one or more quality checks on the data for each scanning frame. If the quality check(s) are passed, the image acquisition engine 112 or the quality check engine 114 can send the scanning frame to the depth map engine 115.

The image processing engine 113 can process the image data and depth values of each scanning frame acquired by the image acquisition engine 112. In some implementations, the image processing engine 113 is configured to determine, e.g., calculate, 3D coordinates of an object. For example, the image processing engine 113 can generate a depth map for each view of the object for which a scanning frame is received from the image acquisition engine 112. The image processing engine 113 can translate a digital image and depth data for the digital image in screen coordinates to a 3D point cloud in real-world coordinates. For each object and/or point on an object in the image, the image processing engine 113 can calculate the position (xrw, yrw, zrw) in the real-world coordinates using the depth data.

In some implementations, the translation calculations are performed using the ideal pinhole-camera model, which transforms the 2D coordinates on an image plane to 3D coordinates in the real world using Equations 1-4 below. The intrinsic properties (K) include pixel focal length (fx and fy) of the camera.

$$K = [ \begin{matrix}{f}_{x} & 0 & {o}_{x} \\ 0 & {f}_{y} & {o}_{y} \\ 0 & 0 & 1\end{matrix} ] \qquad Equation 1$$

$$xrw = ( x - ( K [ 3 ] [ 1 ] ) ) * z / ( K [ 1 ] [ 1 ] ) \qquad Equation 2$$

$$yrw = ( y - ( K [ 3 ] [ 2 ] ) ) * z / ( K [ 2 ] [ 2 ] ) \qquad Equation 3$$

$$zrw = z \qquad Equation 4$$

The image processing engine 113 can send the depth map for each view and the scanning frame for each view to the quality check engine 114. The quality check engine 114 is configured to perform a quality check for each scan to ensure that the data for the scan is high-quality. The quality check can vary for different views of an object and/or for different types of objects. Example quality checks are described below in detail. The quality checks ensure that the data for the object (e.g., the real-world coordinates for each point on the object) is accurate so that the generated 3D reconstruction of the object is also accurate. The quality check engine 114 can send the depth maps and scanning frames that pass the quality check to the depth map engine 115.

The depth map engine 115 is configured to process depth maps to remove noise and/or other items from the depth maps. For example, the depth map engine 115 can be configured to detect and remove faraway background items from depth maps, detect and remove near background items (e.g., floors for foot scans), and/or detect and remove noise points.

In many cases, the object of interest may lie quite close to the scanning device 111. However, the scanning device 111 can capture an object in a wide range of distance. Thus, the depth map engine 115 can detect and remove all the data outside of the interested range. For example, the depth map engine 115 can be configured to remove, from a depth map, each point that has real-world coordinates that fall outside a target range at which the object is determined to be located. The target range of coordinates can refer to the lower and upper bounds of the depth value (in z direction). The lower bound of z can be determined based on characteristics of the scanning device 111, e.g., intrinsic properties of the scanning device 111. For example, the lower bound of z can be determined using experiments. As a particular example, if the distance of the object from the scanning device 111 is less than a minimum depth (z_min), the depth value may be inaccurate or include significant noise. The upper bound of z can be determined from estimation. For example, if the side of a foot is scanned, the maximum depth (z_max) should be z_min plus a reasonable estimation of the width of a human's foot, e.g., around 30 centimeters.

If the object lays on the floor (or another surface) or there are other objects surrounding the object, the depth map engine 115 can remove the floor and other surrounding objects. The floor or surrounding objects may have unique and consistent characteristics that can be identified and then filtered. For example, a floor surface has very low variance in height, and all the points within certain distance of the surface plane can be treated as floor.

The depth map engine 115 can also detect and remove the noise points near the edges of the object being scanned. Usually, these noise points can result from a scanning device itself, which has unique features regarding the point density and distribution pattern, thus can be identified and removed. These depth map processing techniques can be applied to both discrete (non-continuous) scans and continuous scans. The depth map engine 115 can send the processed depth maps to the 3D reconstruction engine 116.

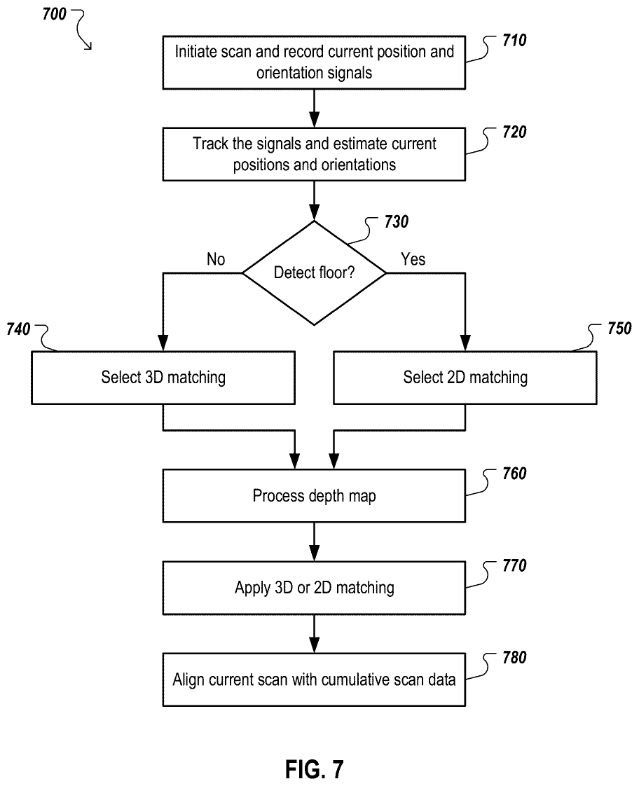

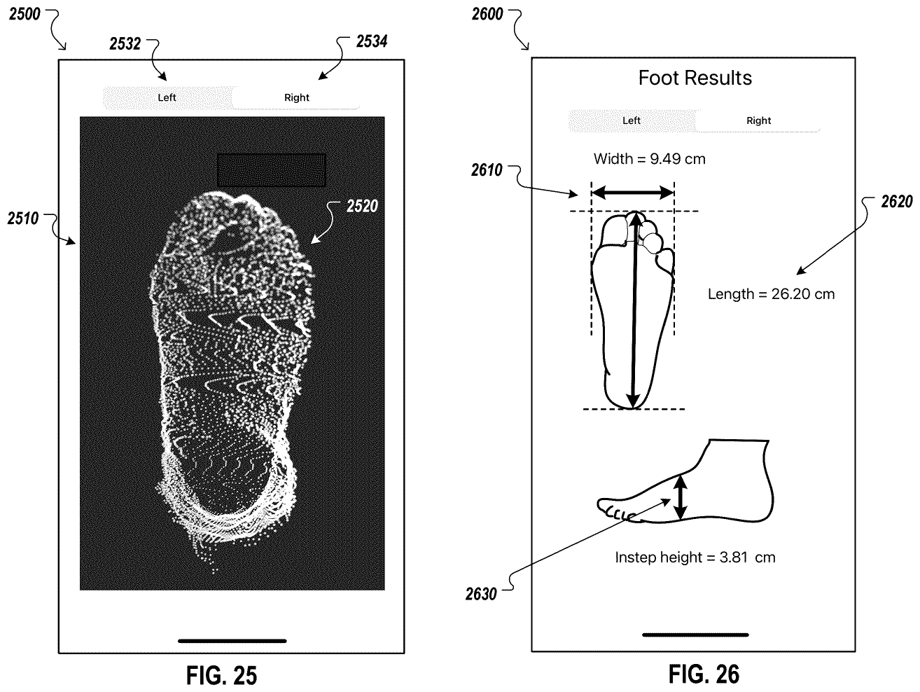

The 3D reconstruction engine 116 is configured to generate a 3D reconstruction of the object using the depth scans of the object, e.g., the processed depth scan for each view of the object. The 3D reconstruction can be in the form of a 3D point cloud. A 3D point cloud is a collection of data points for the object and each data point represents the real-world coordinates of the object. The 3D reconstruction engine 116 can use various techniques for generating 3D reconstructions. For example, the 3D reconstruction engine 116 can use iterative closest point (ICP) techniques and/or simultaneous localization and mapping (SLAM) techniques. An example process for generating a 3D reconstruction using depth maps is shown in FIG. 7 and described below. An example 3D point cloud is shown in FIG. 25.

The 3D model analysis engine 117 is configured to determine, e.g., calculate, metrics and/or other measurements of parameters of the objects using the 3D reconstruction of the object. For example, the 3D model analysis engine 117 can be configured to determine the width, length, and instep height of a foot using a 3D reconstruction of the foot.

In some implementations, the 3D model analysis engine 117 can perform a set of analysis to extract a set of metrics of the target objects. The 3D object can be projected to any plane to obtain the projected 2D outline of the 3D object. The ID geometric parameters, such as length, width, and instep height can be calculated from the 2D outline. 2D geometric parameters, such as girth, circumstance of any cross-section can also be calculated.

As an example, for the bottom foot parameter analysis, a reference plane (x, y) can be found by minimizing the distance of all foot points and targeted plane. Then, the foot bottom from the reconstructed 3D object is projected to the reference plane, and a 2D outline of the foot bottom boundary is obtained. Using the principal component analysis (PCA) method, the principal axis of the 2D outline is identified. The highest and lowest points along the principal axis are identified by rotating the 2D outline. The length and width of the foot are calculated from these points. Besides the length and width, other 1D geometric parameters, such as instep height, heel width can be calculated from side and back scans using the same methods.

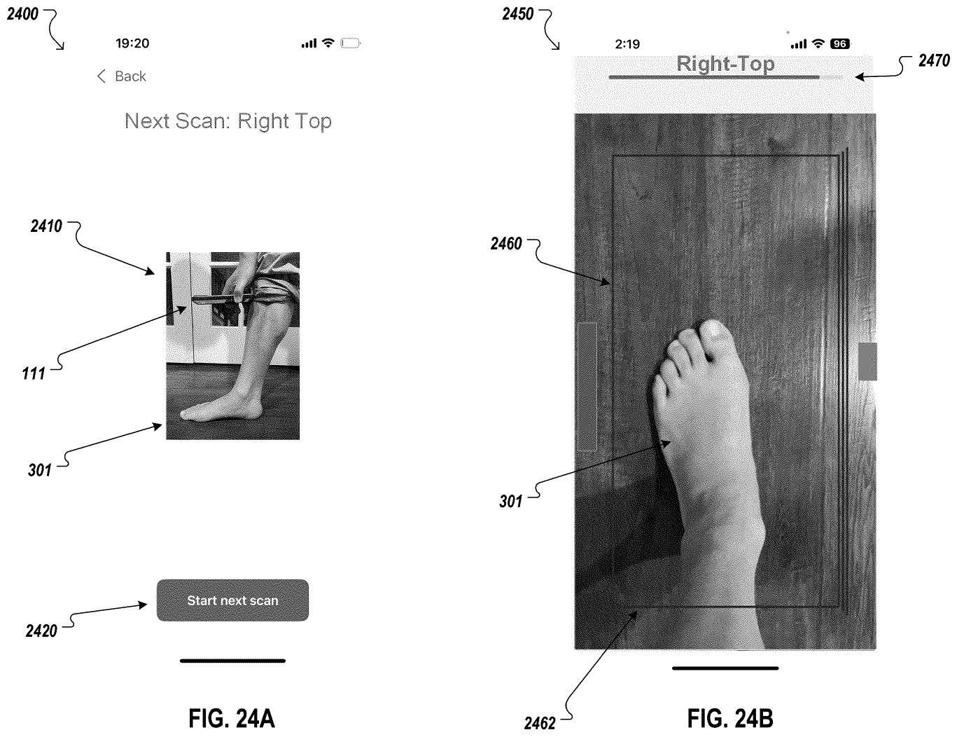

The 3D reconstruction and/or the calculated measurements/metrics of the object can be displayed by the display device 120. For example, the 3D reconstruction system 110 (or an engine/module thereof) can be configured to generate and update user interfaces that show the 3D reconstruction and/or measurements/metrics. Examples of these interfaces are shown in FIGS. 24 and 25 and described below.

The 3D reconstruction and/or measurements can also be used to create another object or to generate a recommendation. For example, the 3D reconstruction of a foot can be used to make a custom shoe using a shoe last technique. In particular, the 3D reconstruction can be used to generate a real-world 3D form, e.g., using additive manufacturing, and this form can be used in the shoe last technique to make the shoe. Thus, the outputs of the 3D reconstruction system 110 can be sent to another device or machine (e.g., a 3D printer) for use in making other objects, e.g., shoes.

In another example, the measurements of the foot can be used to recommend a shoe size for the user. As the actual sizes of shoes can vary by manufacturer and model, the accurate foot measurements can be used along with actual dimensions of the shoes to recommend shoes that will best fit the user's foot and/or provide the most comfort for the user.

FIG. 3 depicts an example set of scans 300 of a person's foot 301. In this example, the set of scans 300 includes six discrete scans: front scan 310, back scan 320, outer scan 330, inner scan 340, bottom scan 350, and top scan 360. The bottom scan 350 captures characteristics of the bottom of the foot including the shape of the bottom of the foot 301, a foot arch height, and the arch shape. The inner scan 340 captures characteristics of the inner side of the foot, such as ball joint, thumb toe, inner ankle shape etc. The outer scan 330 captures the characteristics of the outer side of the foot, such as the pinky toe, outer ankle shape, etc. The front scan 310 captures the shapes of five toes as well as the upper surface of the foot 301. The back scan 320 captures the heel and the overall shape of the ankle. The top scan 360 captures the shapes of the five toes and characteristics of the upper surface of the foot including the shape and dimensions of the top of the foot. Using this set of scans 300 enables the full view of the foot to be captured. However, the number of scans is not limited to six. More scans than six can provide additional details of the foot, which are not necessary but useful to generate a 3D reconstruction of a foot. Fewer than six scans can also be used, but may provide less detail in some situations. The number of scans can also vary based on the type of the object for which a 3D reconstruction is being generated.

For example, the number of scans can be five scans. Any of the five scans can be used. In a particular example, the five scans can include a front scan, an inner scan, an outer scan, a bottom scan, and a back scan, but not the top scan. In another example, the five scans can include a front scan, an inner scan, an outer scan, a top scan, and a back scan, but not the bottom scan. Any other combination of two or more of the illustrated scans can be used in any order.

Each scan can have a target distance or distance range from which the scanning device 111 (e.g., the lens of the scanning device 111) should be from the object. For example, the front scan 310 has a target distance 311; the back scan 320 has a target distance 321; the outer scan 330 has a target distance 331; the inner scan 340 has target distance 341; the bottom scan 350 has a target distance 351; and the top scan 360 has a target distance 361. The target distances for the different views can differ or be the same. For example, the target distance for each scan can be around eight inches for some cameras and feet, while the target distance may be around ten inches for other cameras or objects.

The target distances or distance ranges can be set such that the images captured by the scanning device are high-quality and provide accurate image data for use in generating depth maps and 3D reconstructions. The target distances or distance ranges can vary based on the camera(s) being used, the object being scanned, the size of the object being scanned (e.g., the target distance can vary based on foot size) and/or other parameters. The target distances or distance ranges can be determined experimentally, e.g., by capturing images of the objects using the different cameras and evaluating their quality in generating depth maps and 3D reconstructions. The target distance or distance ranges for each object, type of object, and/or size of object can be stored by the 3D reconstruction system 110.

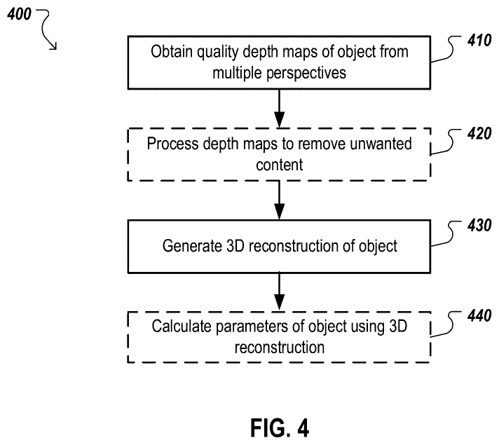

FIG. 4 is a flow chart of an example process 400 for generating a 3D reconstruction of an object. Operations of the process 400 can be performed by a 3D reconstruction system, e.g., the 3D reconstruction system 110 of FIG. 1 or FIG. 2 or another data processing apparatus. The operations of the process 400 can also be implemented as instructions stored on a computer readable medium, which can be non-transitory. Execution of the instructions, by one or more data processing apparatus, causes the one or more data processing apparatus to perform operations of the process 400. For brevity, the process 400 is described as being performed by a 3D reconstruction system.

The 3D reconstruction system obtains quality depth maps for an object from multiple perspectives (410). The quality depth maps can be obtained by capturing image data using a scanning device (e.g., one or more cameras) from each perspective. As described above, the image data can include, for example, a digital image of a scene and depth data. The depth map for each perspective can be generated using the depth data. In some implementations, the depth data can be obtained from a depth sensor, e.g., directly from the depth sensor. In some implementations, the depth data can be obtained from images captured from multiple cameras, as described elsewhere herein.

A quality check can be performed for each depth map for each perspective. To obtain quality depth maps, the 3D reconstruction system can capture image data and generate depth maps for each perspective until a depth map from each perspective passes its quality check.

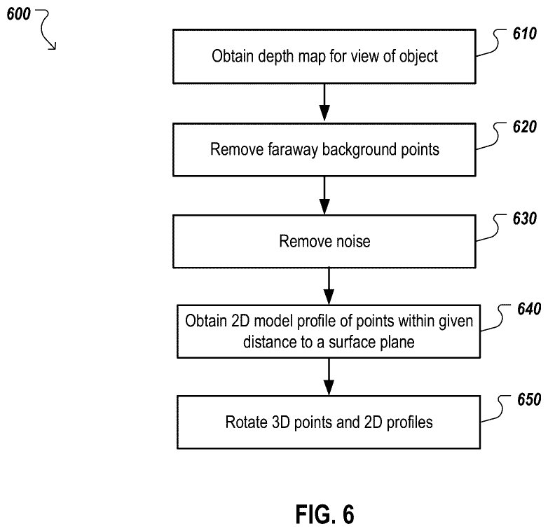

Optionally, the 3D reconstruction system processes the depth maps to remove unwanted content, e.g., coordinates for background objects and/or noise points. An example process for processing depth maps is shown in FIG. 6 and described below.

The 3D reconstruction system generates a 3D reconstruction of the object using the depth maps (430). For example, the 3D reconstruction system can generate a 3D point cloud of the object using the depth maps. An example process for generating a 3D reconstruction using depth maps is shown in FIG. 7 and described below.

Optionally, the 3D reconstruction system determines measurements and/or other metrics of parameters of the object using the 3D reconstruction (440). For example, the 3D reconstruction system can determine the length, width, and instep height of a foot using 2D planes extracted from the 3D reconstruction.

The 3D reconstruction system can display the 3D reconstruction and the measurements/metrics of the parameters at a display device. In another example, the 3D reconstruction system can output the 3D reconstruction and/or measurements/metrics to another device or system, e.g., to a 3D printer or other additive manufacturing device.

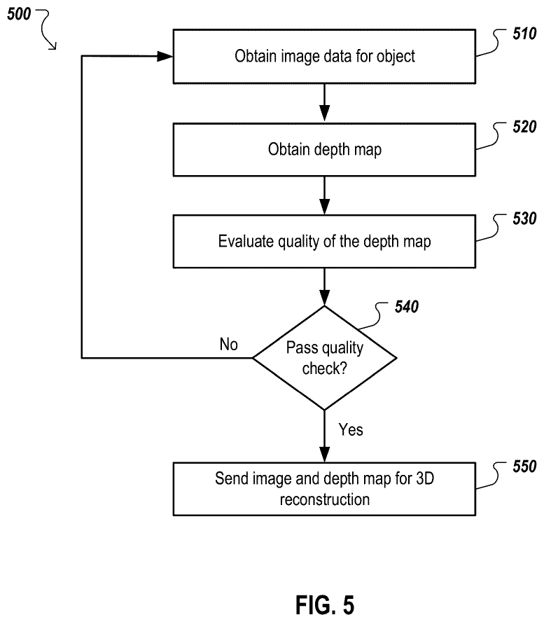

FIG. 5 is a flow chart of an example process 500 for evaluating the quality of a depth map. Operations of the process 500 can be performed by a 3D reconstruction system, e.g., the 3D reconstruction system 110 of FIG. 1 or FIG. 2 or another data processing apparatus. The operations of the process 500 can also be implemented as instructions stored on a computer readable medium, which can be non-transitory. Execution of the instructions, by one or more data processing apparatus, causes the one or more data processing apparatus to perform operations of the process 500. For brevity, the process 500 is described as being performed by a 3D reconstruction system.

The 3D reconstruction system obtains image data for an object (510). For example, a scanning device can capture one or more images of the object from a particular perspective as described above.

The 3D reconstruction system obtains a depth map that represents depth data (520). As described above, a digital image and depth data for the image can be translated from screen coordinates to a 3D point cloud in real-world coordinates. For each point in the image, the 3D reconstruction system can calculate the position (xrw, yrw, zrw) in the real-world coordinates using the depth data. For example, the ideal pinhole-camera model can be used for the transformation, as described above. In some implementations, the 3D reconstruction system obtains the depth map directly from a depth sensor.

The 3D reconstruction system evaluates the quality of the depth map (530). For example, a quality check engine of the 3D reconstruction system can perform one or more quality checks on the depth map (and/or the image and/or depth data corresponding to the depth map) to ensure that the depth data represented by the depth map is accurate based on how the depth data was captured. For example, the quality checks for a depth map or other data can include determining whether the object being scanned is within a target area in the view of the scanning device (e.g., near the center of the view and/or within a bounding box), whether the object is within a target distance or distance range of the scanning device, whether the angle of the object with respect to the scanning device is within a target range, and/or whether other items (e.g., floor or other surface) in the depth map are within target ranges. Thus, the quality checks can include checks of information related to the scanning of the object for which the depth map is obtained or generated. One or more of these quality checks can be performed for each view until accurate data that passed each quality check is obtained for the view. Any combination of the quality checks can be used.

The quality checks performed by the 3D reconstruction system can vary based on the type of object and the view of the object (e.g., the perspective from which the image data was captured). For example, as described in more detail below, the quality checks for the back and front of a foot can differ from the quality checks of the inner and outer sides of the foot.

The 3D reconstruction system determines whether the quality check(s) are passed (540). If there are multiple quality checks, the 3D reconstruction system can determine that the quality checks are passed when all of the multiple quality checks are passed.

If the depth map does not pass the quality check, the 3D reconstruction system can repeat the operations of obtaining image data for the object, generating a depth map, and evaluating the quality of the depth map until a depth map passes the quality check. If the depth map does pass the quality check, the depth map is sent for 3D reconstruction (550).

FIG. 6 is a flow chart of an example process 600 for processing a depth map. Operations of the process 600 can be performed by a 3D reconstruction system, e.g., the 3D reconstruction system 110 of FIG. 1 or FIG. 2 or another data processing apparatus. The operations of the process 600 can also be implemented as instructions stored on a computer readable medium, which can be non-transitory. Execution of the instructions, by one or more data processing apparatus, causes the one or more data processing apparatus to perform operations of the process 600. For brevity, the process 600 is described as being performed by a 3D reconstruction system.

The 3D reconstruction system obtains a depth map for a view of an object (610). For example, the depth map can be generated using the process 500 of FIG. 5.

The 3D reconstruction system removes background points from the depth map (620). As described above, the 3D reconstruction system can include a depth map engine that is configured to detect and remove faraway background items from depth maps and/or to detect and remove near background items (e.g., floors for foot scans). For example, the depth map engine can be configured to remove, from a depth map, each point that has real-world coordinates that fall outside a target range at which the object is determined to be located.

The 3D reconstruction system removes noise points from the depth map (630). For example, the depth map engine can be configured to evaluate features regarding the point density and distribution pattern of points in the depth map. As noise points typically have unique features regarding the point density and distribution pattern, the depth map engine can identify and remove these points.

In some implementations, the depth map engine can be configured to remove noise from around the edge or boundary of the object. A unique feature of these edge points is a high gradient of the depth value as the depth value changes from near the target object to a far background scene. Another unique feature is the particular distribution pattern of the depth values from the scanning device. These features enable the depth map engine to detect the noise at the edge or boundary of the object and the remove the noise.

The 3D reconstruction system obtains a 2D profile of the object being scanned within a given distance of a surface plane (640). The surface plane can be the plane of a surface on which the object being scanned lies at the time of performing the scans. A surface, e.g., a floor or table surface, or surrounding objects may have unique and consistent characteristics that can be identified and then filtered. For example, as described above, a floor surface has very low variance in height, and all the points within certain distance of the surface plane can be treated as floor. The given distance can be a few millimeters (mm), e.g., 2-4 mm, 4-6 mm, 2-6 mm, 2-8 mm, or another appropriate distance which can vary based on the type of object being scanned, the surface (e.g., the roughness level of the surface), and/or the scanning device.

The 3D reconstruction system can identify the surface plane in the depth map and identify all the points in the depth map that are within a given distance to the surface plane. The 3D reconstruction system can generate a 2D profile of all the points that are within the given distance, which represents the object being scanned.

The 3D reconstruction system rotates 3D points and 2D profiles of the side scans to align the side scans with other scans (e.g., bottom, front, and back scans) with a unified coordinate system (650). Therefore, all the 3D points from different scans have paralleling floor or reference planes, whose z axes are perpendicular to a particular direction (e.g., the direction of gravity), to allow 3D reconstruction in subsequent operations.

FIG. 7 is a flow chart of an example process 700 for generating a 3D reconstruction using depth maps. Operations of the process 700 can be performed by a 3D reconstruction system, e.g., the 3D reconstruction system 110 of FIG. 1 or FIG. 2 or another data processing apparatus. The operations of the process 700 can also be implemented as instructions stored on a computer readable medium, which can be non-transitory. Execution of the instructions, by one or more data processing apparatus, causes the one or more data processing apparatus to perform operations of the process 700. For brevity, the process 700 is described as being performed by a 3D reconstruction system.

Many scanning devices are equipped with acceleration and gyro sensors. When the scanner is pointed at the object of interest and the scan is initiated, the 3D reconstruction system can record the scanner location and orientation information based on the inputs of acceleration and gyro sensors. During the scanning process, it is important to track the scanner's instant position and orientation information. The classical registration algorithms (e.g., ICP) can be applied to match the current depth map with cumulative scan data. The matching can use the full rotation and translation matrix for the current depth map. To improve the matching speed and convergence probability, the initial guess of rotation and translation matrix can be based on the estimated scanner position and orientation across the scan.

If the floor or any flat surfaces are involved during the scan, there is opportunity to apply the other approaches, like converting the 3D matching to a 2D matching task. However, if there is no flat surface detected, the task can remain a 3D matching task. In some cases, it might useful to apply some quick processing to the continuous depth map, e.g., to remove the background and noises.

The 3D reconstruction system initiates the scan of an object and records a current position signal and a current orientation signal (710). The scan of the object can include obtaining scanning frames for each scan in a set of scans. The orientation signal can be received from a gyro sensor. The 3D reconstruction system can store the signals as initial signals for the scan.

The 3D reconstruction system tracks signals from an accelerometer and the gyro sensor throughout the scan and determines, e.g., estimates, the current position and current orientation based on the signals (720). The 3D reconstruction system can record the estimated position and orientation with each scanning frame captured.

The 3D reconstruction system determines whether a floor is detected (730). The floor can be detected as described elsewhere herein.

If a floor is detected, the 3D reconstruction selects to perform 3D matching (740). If a floor is not detected, the 3D reconstruction system selects to perform 2D matching (750).

The 3D reconstruction system performs depth map processing (760). For example, the 3D reconstruction system can process the continuous depth map to remove the background and noises using background and noise removal techniques described herein.

The 3D reconstruction system applies 2D or 3D matching algorithm (770). For example, the 3D reconstruction system can use ICP, SLAM, or other 3D reconstruction techniques using the initial position and orientation signals (e.g., the signals for the scan of the first view) to match the depth map of the current scan with depth maps of cumulative scan data.

The 3D reconstruction system applies rotation and translation matrix to align the depth map of the current scan with the cumulative scan data (780).

Optimization of the entire process of depth map analysis and 3D reconstruction is important. For example, the depth map analysis of each captured depth map that passed its quality check can take some time. Also, 3D reconstruction can only start with at least two processed depth map data. Therefore, streamlining the data analysis and 3D reconstruction process is important to achieve robust and efficient results.

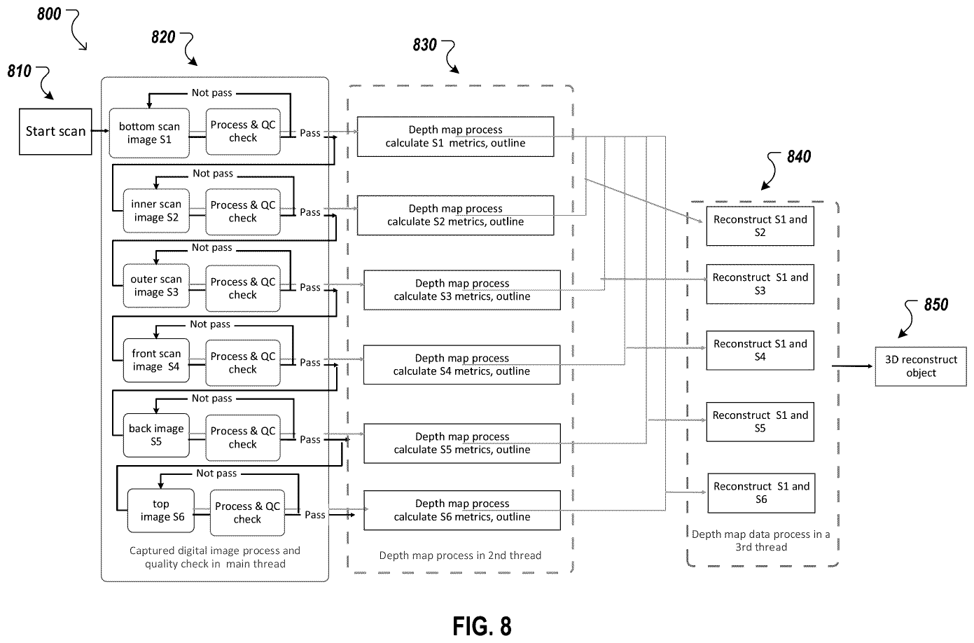

FIG. 8 is a flow chart of an example process 800 for generating a 3D reconstruction of an object. Operations of the process 800 can be performed by a 3D reconstruction system, e.g., the 3D reconstruction system 110 of FIG. 1 or FIG. 2 or another data processing apparatus. The operations of the process 800 can also be implemented as instructions stored on a computer readable medium, which can be non-transitory. Execution of the instructions, by one or more data processing apparatus, causes the one or more data processing apparatus to perform operations of the process 800. The example process 800 is described in terms of generating a 3D reconstruction of a foot, but a similar process can be performed for other objects using different scans of those objects. Additionally, the various scans of the foot are described as being performed in a particular order. However, the scans can be performed in any order.

The example process 800 includes a discrete scanning process and 3D reconstruction process with separate parallel threads for computation. At 810, the scan process is started.

A first thread 820 captures a series of scans and evaluates the scans using quality checks. Although the scans in the first thread 820 are shown in a particular order, the scans can be obtained in any order.

In this example, the first scan is a bottom scan of the bottom of a foot. As the bottom scan starts, the scanning frame is received and sent for processing and quality check. If the quality check is not passed, the next scanning frame from bottom scan is received and processed for quality check again. Once the quality check is passed, the next scan will start in the first thread 820. In this example, the next scan is the inner scan of the inner side of the foot. In addition, the depth map process is triggered, e.g., immediately, in a second thread 830, e.g., in the background, to calculate foot metrics and a 2D foot outline, without delaying the next inner scan. The depth scan process for each scan can include determining a depth map for the view using depth data, generating a 2D outline of that view of the foot, and/or calculating dimensions or other metrics for that view of the foot.

Similarly, once an inner scan passes the quality check, the outer scan will be initiated immediately in the first thread 820, and depth map process is triggered in the second thread 830 for the inner scan. If the depth image process of both the bottom scan and the inner scan are completed, the 3D reconstruction process is triggered for the bottom and inner scans in a third thread 840 in parallel with the first thread 820 and the second thread 830, without impacting the tasks in the first thread 820 and the second thread 830. For example, the orientation and position information can be used along with the depth maps to generate the 3d reconstruction of the two views of the foot for each pair of views processed in the third thread 840.

Once an outer scan passes the quality check, the front scan will be initiated, e.g., immediately, in the first thread, and depth map process is triggered in the second thread 830 for the outer scan. If the depth image process of both the bottom scan and the outer scan are completed, the 3D reconstruction process is triggered for the bottom and outer scans in the third thread 840 in parallel with the first thread 820 and the second thread 830, without impacting the tasks in the first thread 820 and the second thread 830.

Once a front scan passes the quality check, the back scan will be initiated, e.g., immediately, in the first thread, and depth map process is triggered in the second thread 830 for the front scan. If the depth image process of both the bottom scan and the front scan are completed, the 3D reconstruction process is triggered for the bottom and front scans in the third thread 840 in parallel with the first thread 820 and the second thread 830, without impacting the tasks in the first thread 820 and the second thread 830.

Once a back scan passes the quality check, the top scan will be initiated, e.g., immediately, in the first thread, and depth map process is triggered in the second thread 830 for the back scan. If the depth image process of both the bottom scan and the back scan are completed, the 3D reconstruction process is triggered for the bottom and back scans in the third thread 840 in parallel with the first thread 820 and the second thread 830, without impacting the tasks in the first thread 820 and the second thread 830.

Once a top scan passes the quality check, the depth map process is triggered in the second thread 830 for the top scan. If the depth image process of both the bottom scan and the top scan are completed, the 3D reconstruction process is triggered for the bottom and top scans in the third thread 840.

After all the 3D reconstructions processes are completed in the third thread 840, the 3D reconstruction of the entire object is generated at 850. For example, the orientation and position information for each scan can be used to connect the 3D reconstructions for each pair of views into a final 3D reconstruction of the entire foot. The 3D reconstruction can then be displayed by a display device and/or used to generate measurements of parameters of the foot. As described herein, the 3D reconstruction can be in the form of a 3D point cloud. Using multiple parallel threads in this way improves the speed and efficient of generating the 3D reconstruction of the object.

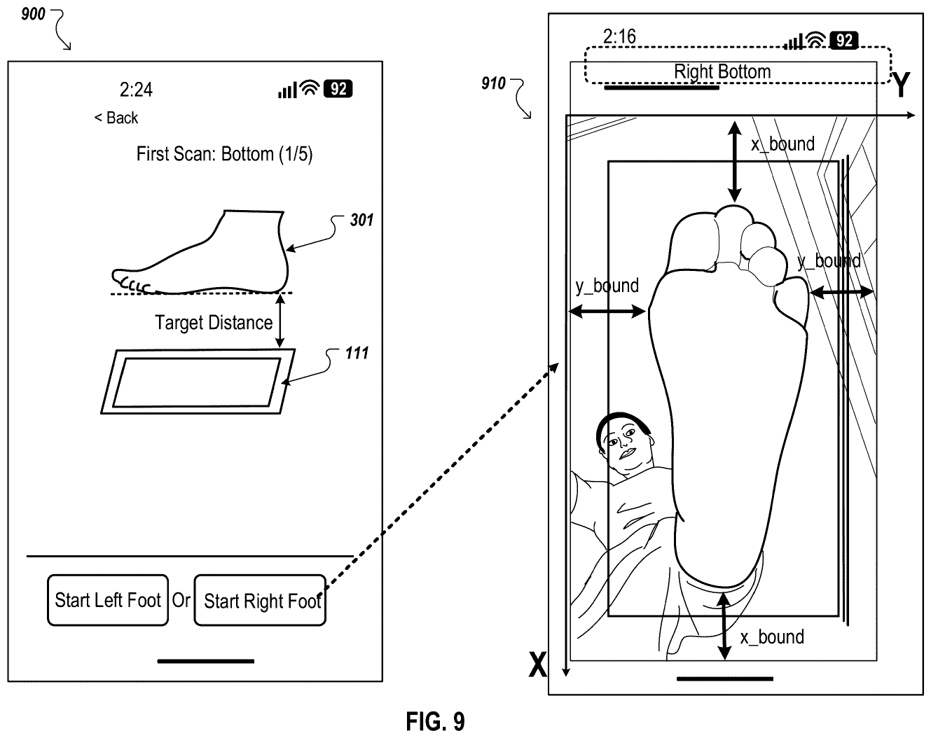

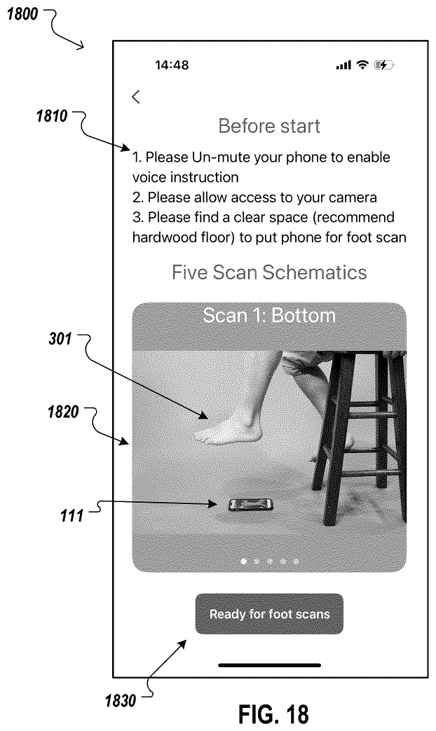

FIGS. 9-19 illustrate techniques for obtaining scans of different view of a person's foot and performing quality checks on depth scans generated using depth data from the scans. Some of these figures also illustrate user interfaces that can be used to obtain the scans. The user interfaces are described in more detail with reference to FIGS. 18-24B.

FIG. 9 depicts a scan 900 of a bottom of a foot 301 of a user. The user can place the scanning device 111 flat on a surface, e.g., the floor, and align their foot 301 over the scanning device 111. An example interactive user interface 910 shows the position of the foot 301 with respect to the x-axis and the y-axis. As described above, the scanning device can also detect the depth from the scanning device to each point in an image along the z-axis, e.g., using multiple RGB cameras, depth cameras, and/or LiDAR cameras.

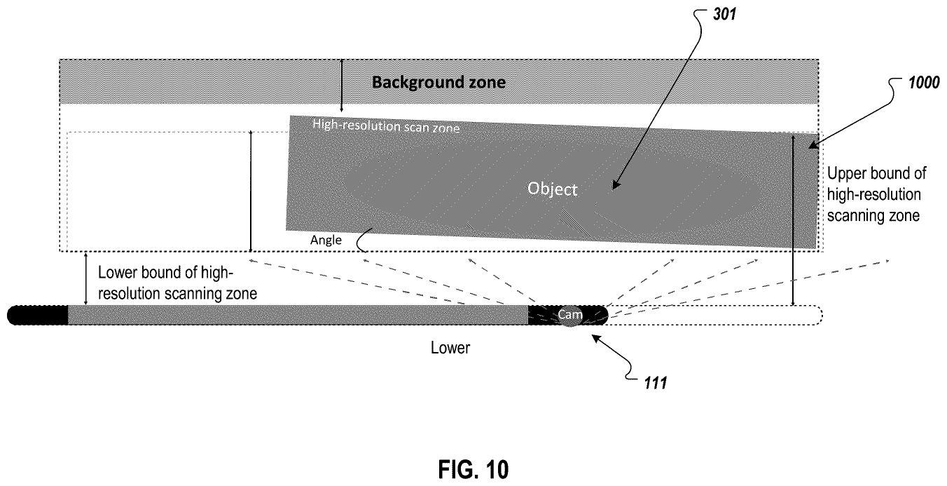

FIG. 10 depicts a target scan zone 1000 for generating a depth scan of a bottom of a foot 301. The target scan zone 1000 represents a target area in which the image data captured for the foot 301 has high resolution and the corresponding depth data has high accuracy. The target scan zone 1000 can vary based on the view or perspective for the scan, the object being scanned, the camera(s) of the scanning device 111, and/or other factors. The target scan zone 1000 can be predefined based on these factors, e.g., based on experiments for determining the target scan zone 1000.

In general, the coordinates of the points on the foot 301 in the target scan zone 1000 will be extracted for analysis and 3D reconstruction, e.g., if the quality check is passed. Ideally, the entire foot 301 should be within this target scan zone 1000. Removing foot data beyond the upper bound of the high-resolution scanning zone filters out the background noise. Any object that is beyond the lower or upper bound of the high-resolution scanning zone can result in invalid or low-resolution data.

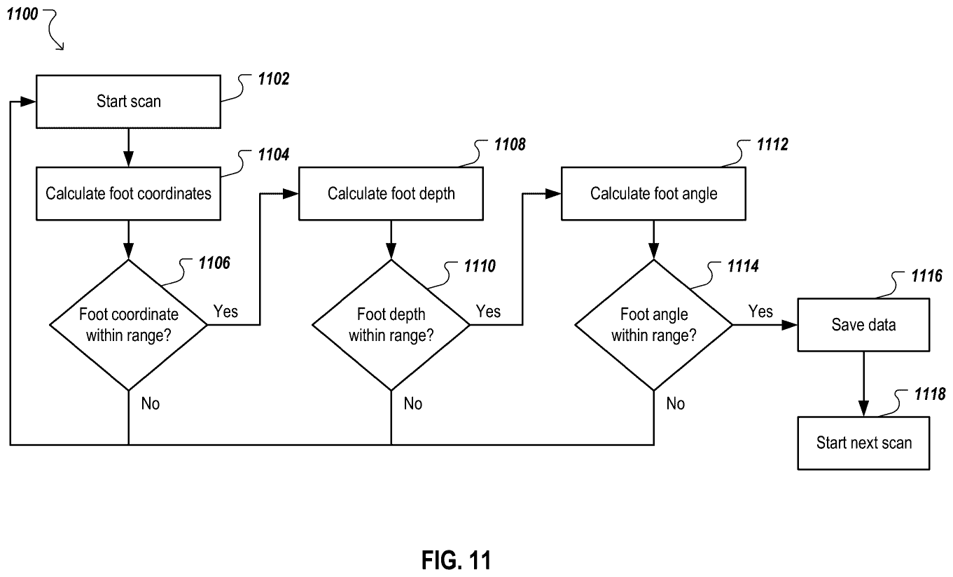

FIG. 11 is a flow chart of an example process 1100 for performing a quality check on a depth scan of a bottom of a foot 301. Operations of the process 1100 can be performed by a 3D reconstruction system, e.g., the 3D reconstruction system 110 of FIG. 1 or FIG. 2 or another data processing apparatus. The operations of the process 1100 can also be implemented as instructions stored on a computer readable medium, which can be non-transitory. Execution of the instructions, by one or more data processing apparatus, causes the one or more data processing apparatus to perform operations of the process 1100. For brevity, the process 1100 is described as being performed by a 3D reconstruction system.

The 3D reconstruction system starts the scan (1102). This can include obtaining image data for a scan, e.g., a scanning frame for the scan. This can also include generating or otherwise obtaining a depth map for the scan.

The 3D reconstruction system calculates foot coordinates for the foot (1104). These coordinates can include the x-bound and y-bound of the foot 301, as shown in FIG. 9. The x-bound represents the boundary of the foot 301 along the x-axis and the y-bound represents the boundary of the foot 301 along the y-axis. For example, the x-bound can indicate the highest x-coordinate occupied by the foot in an image (e.g., digital image) and the lowest x-coordinate occupied by the foot 301 in an image. Similarly, the y-bound can indicate the highest y-coordinate occupied by the foot in an image and the lowest y-coordinate occupied by the foot 301 in an image.

The 3D reconstruction system determines whether the foot coordinates are within a target range for the foot coordinates (1106). The target range can be defined by the target scan zone 1000. For example, the target range can be the x and y coordinates of a bounding box that defines the target scan zone.

If at least a threshold amount of the foot coordinates are not within the target range for the foot coordinates, the process 1100 can return to (1102) at which another scan is obtained. The threshold amount can vary based on the implementation. In some implementations, the threshold can be one meaning that all foot coordinates must be within the target range. In some implementations, a higher amount, e.g., 5%, 10%, 20%, or another appropriate percentage of the foot coordinates can be outside the range. However, higher percentages can result in lower data quality.

In some implementations, the 3D reconstruction system can also provide instructions to the user to move the foot 301 into the proper position. For example, the 3D reconstruction system can output an audible voice prompt that includes the instructions. An example voice prompt may be “foot is out of the box.” Directional instructions can also be used, e.g., “move your foot to the left.” The use of audio is particularly advantageous since the user may not be holding the scanning device 111 and may not be able to view the screen of the scanning device 111.

If all foot coordinates are within the target range, the 3D reconstruction system calculates the foot depth (1108). The foot depth can represent the minimum distance between the foot 301 and the scanning device 111 (e.g., the lens of a camera or surface of the scanning device 111). The 3D reconstruction system can calculate the foot depth using the depth map, e.g., using the z-coordinate of each point on the foot 301 in the depth map.

The 3D reconstruction system determines whether the foot depth is within a target range for the foot depth (1110). The target range for the foot depth can define a minimum and maximum target distance from the scanning device 111 to the foot 301.

If the foot depth is not within the target range for the foot depth, the process 1100 can return to (1102) at which another scan is obtained. In some implementations, the 3D reconstruction system can also provide instructions to the user to move the foot 301 into the proper position. For example, the 3D reconstruction system can output an audible voice prompt that includes the instructions. An example voice prompt may be “too close” if the foot is too close to the scanning device 111 or “too far away” if the foot is too far from the scanning device 111.

If the foot depth is within the target range, the 3D reconstruction system calculates a foot angle (1112). The foot angle represents an angle between the foot plane and the scanning device 111 (e.g., a surface of the scanning device 111). The 3D reconstruction system can calculate the foot angle using the extracted foot data. The principal coordinate of the foot can be calculated by applying a PCA method. In this example, the foot angle is the angle between the principal coordinate and the reference x-coordinate.

The 3D reconstruction system determines whether the foot angle is within a target range for the foot angle (1114). This angle should be a low as possible to obtain accurate data. Thus, the 3D reconstruction system can compare the foot angle to a target range (e.g., a maximum threshold) to ensure that the foot angle is not too high.

If the foot angle is not within the target range for the foot angle, the process 1100 can return to (1102) at which another scan is obtained. In some implementations, the 3D reconstruction system can also provide instructions to the user to move the foot 301 into the proper orientation. For example, the 3D reconstruction system can output an audible voice prompt that includes the instructions. An example voice prompt may be “keep your foot flat.”

If the foot angle is within the target range, the quality check is passed is passed successfully and the data (e.g., scanning frame, depth map, and/or calculated foot data) is stored (1116). If there are additional scans, the next scan can be initiated (1118).

In this example, the foot coordinates, foot depth, and foot angle are calculated and compared to target ranges in a particular order. However, this order can vary in different implementations. For example, the foot depth or foot angle could be calculated and compared to a target range first in other examples.

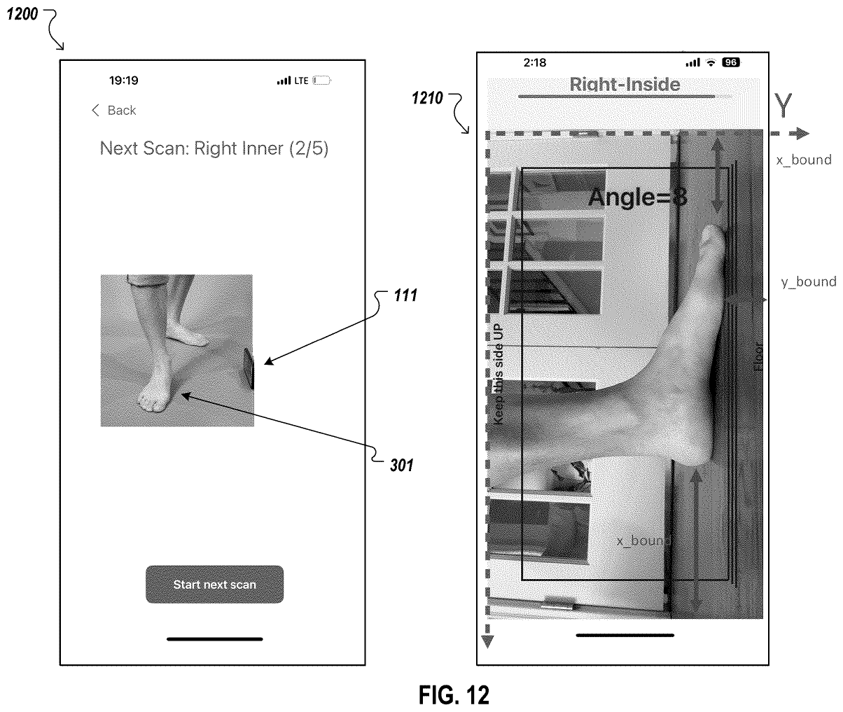

FIG. 12 depicts a scan 1200 of a side of a foot 301 of a user. The user can place the scanning device 111 on its side on a surface, e.g., the floor, and align their foot 301 beside the scanning device 111. An example interactive user interface 1210 shows the position of the foot 301 with respect to the x-axis and the y-axis.

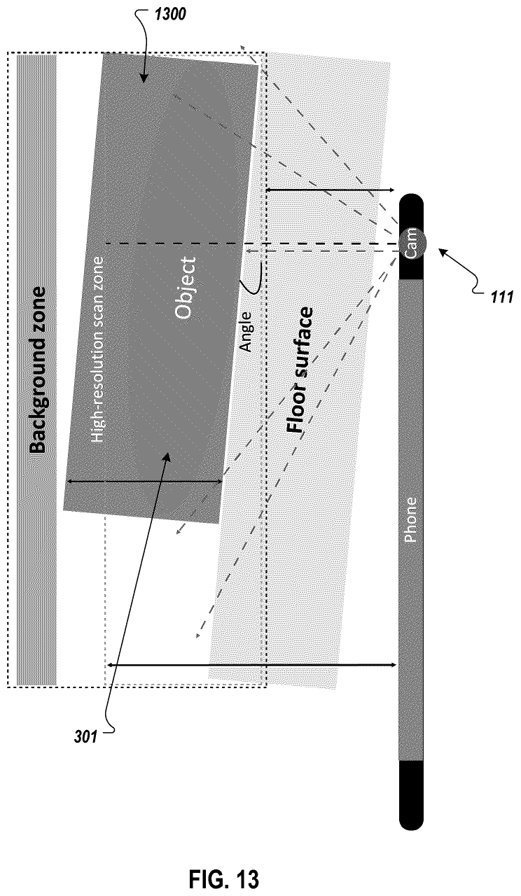

FIG. 13 depicts a target scan zone 1300 for generating a depth scan of a side of a foot 301. The target scan zone 1300 represents a target area in which the image data captured for the foot 301 has high resolution and the corresponding depth data has high accuracy.

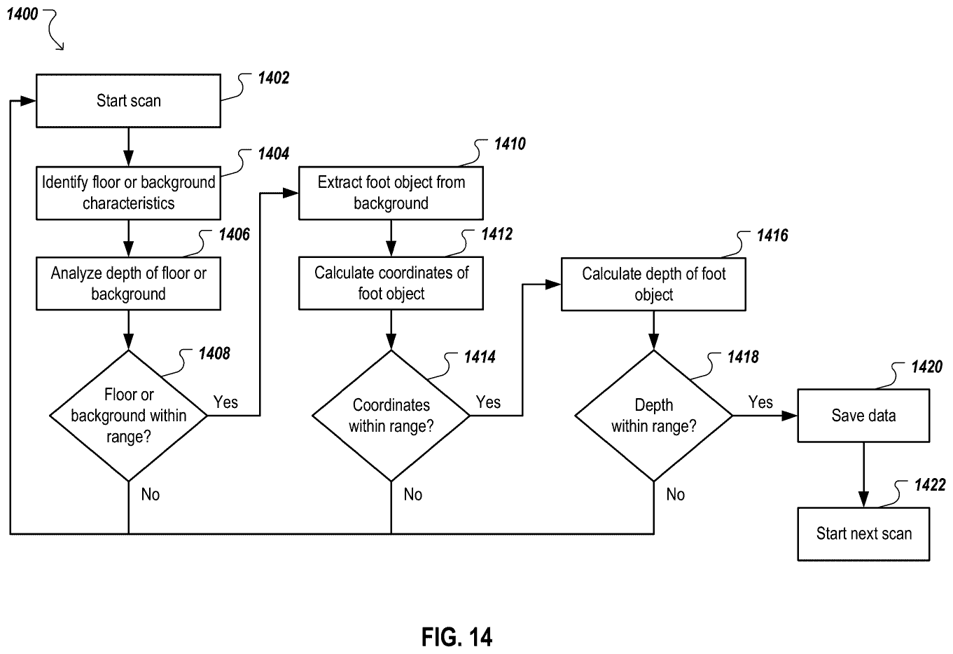

FIG. 14 is a flow chart of an example process 1400 for performing a quality check on a depth scan of a side of a foot. Operations of the process 1400 can be performed by a 3D reconstruction system, e.g., the 3D reconstruction system 110 of FIG. 1 or FIG. 2 or another data processing apparatus. The operations of the process 1400 can also be implemented as instructions stored on a computer readable medium, which can be non-transitory. Execution of the instructions, by one or more data processing apparatus, causes the one or more data processing apparatus to perform operations of the process 1100. For brevity, the process 1400 is described as being performed by a 3D reconstruction system.

The quality check for the side scan can be similar to that of the bottom scan described above with reference to FIG. 11. For example, the minimum distance and angle between foot 301 and scanning device 111, and x-bound and y-bound from pixel plane can be calculated and used in the quality check. One difference between the quality checks for the bottom scan and the side scans is the addition of processing object placing plane. The quality check for the side scan can be used for both the inner side and outer side of the foot 301.

During the side scan of a foot, a significant portion of the foot placing surface (e.g., the floor surface in the foot scan example) in the target scan zone 1300 may be captured. Other than filtering the background noise that is beyond the target scan zone 1300, the floor should be identified and filtered out from the foot object.

The 3D reconstruction system starts the scan (1402). This can include obtaining image data for a scan, e.g., a scanning frame for the scan. This can also include generating or otherwise obtaining a depth map for the scan.

The 3D reconstruction system identifies the floor and/or background characteristics in the depth map (1404). As described above, the floor or surrounding objects may have unique and consistent characteristics that can be identified. For example, a floor surface has very low variance in height, and all the points within certain distance of the surface plane can be treated as floor. This enables the 3D reconstruction system to identify the floor in the depth map. Compared to the points of the target object (e.g., foot on a floor), the points of the floor have lowest height as the object is placed on top of it. An average height of the points of the floor can be calculated and used to compare against the height of all other points. If the height of a certain point is lower than the average value, this point will be identified as part of the floor.

The 3D reconstruction system analyzes the depth of the floor or background (1406). The 3D reconstruction system can determine the depth of the floor or background based on the analysis. For example, the 3D reconstruction system can identify the z-coordinate values of points on the identified floor or background.

The 3D reconstruction system determines whether the floor or background is within a target range (1408). If not, the process 1400 can return to (1402) at which another scan is obtained. This can help the user control the orientation of the scanning device to ensure high quality data. For example, this can help guide the user to hold a phone-based scanning device upright during the side scan. If the minimum distance between the floor and the screen of the phone is too low, it means the phone is tilted rather than vertical to the floor. If the floor or background is not within the target range, a voice guide can be triggered to instruct the user to adjust the orientation of the scanning device, e.g., “keep the phone upright.”

The 3D reconstruction system extracts the foot object from the background and floor (1410). The foot object can be extracted by comparing the calculated distances of all points from the floor plane to an average distance of the points on the floor plane.

The 3D reconstruction system calculates foot coordinates for the foot (1412). These coordinates can include the x-bound and y-bound of the foot 301, as shown in FIG. 12. The x-bound represents the boundary of the foot 301 along the x-axis and the y-bound represents the boundary of the foot 301 along the y-axis. For example, the x-bound can indicate the highest x-coordinate occupied by the foot in an image or depth map and the lowest x-coordinate occupied by the foot 301 in an image or depth map. Similarly, the y-bound can indicate the highest y-coordinate occupied by the foot in an image or depth map and the lowest y-coordinate occupied by the foot 301 in an image or depth map.

The 3D reconstruction system determines whether the foot coordinates are within a target range for the foot coordinates (1414). The target range can be defined by the target scan zone 1300. For example, the target range can be the x and y coordinates of a bounding box that defines the target scan zone.

If one or more of the foot coordinates are not within the target range for the foot coordinates, the process 1100 can return to (1402) at which another scan is obtained. In some implementations, the 3D reconstruction system can also provide instructions to the user to move the foot 301 into the proper position. For example, the 3D reconstruction system can output an audible voice prompt that includes the instructions. An example voice prompt may be “foot is out of the box.” Directional instructions can also be used, e.g., “move your foot to the left.” The use of audio is particularly advantageous since the user may not be holding the scanning device 111 and may not be able to view the screen of the scanning device 111.

If all foot coordinates are within the target range, the 3D reconstruction system calculates the foot depth (1416). The foot depth can represent the minimum distance between the foot 301 and the scanning device 111 (e.g., the lens of a camera or surface of the scanning device 111). The 3D reconstruction system can calculate the foot depth using the depth map, e.g., using the z-coordinate of each point on the foot 301 in the depth map.

The 3D reconstruction system determines whether the foot depth is within a target range for the foot depth (1418). The target range for the foot depth can define a minimum and maximum target distance from the scanning device 111 to the foot 301.

If the foot depth is not within the target range for the foot depth, the process 1100 can return to (1402) at which another scan is obtained. In some implementations, the 3D reconstruction system can also provide instructions to the user to move the foot 301 into the proper position. For example, the 3D reconstruction system can output an audible voice prompt that includes the instructions. An example voice prompt may be “too close” if the foot is too close to the scanning device 111 or “too far away” if the foot is too far from the scanning device 111.

If the foot depth is within the target range, the quality check is passed successfully and the data (e.g., scanning frame, depth map, and/or calculated foot data) is stored (1420). If there are additional scans, the next scan can be initiated (1422).

In this example, the foot coordinates and foot depth are calculated and compared to target ranges in a particular order. However, this order can vary in different implementations. For example, the foot depth could be calculated and compared to a target range first in other examples.

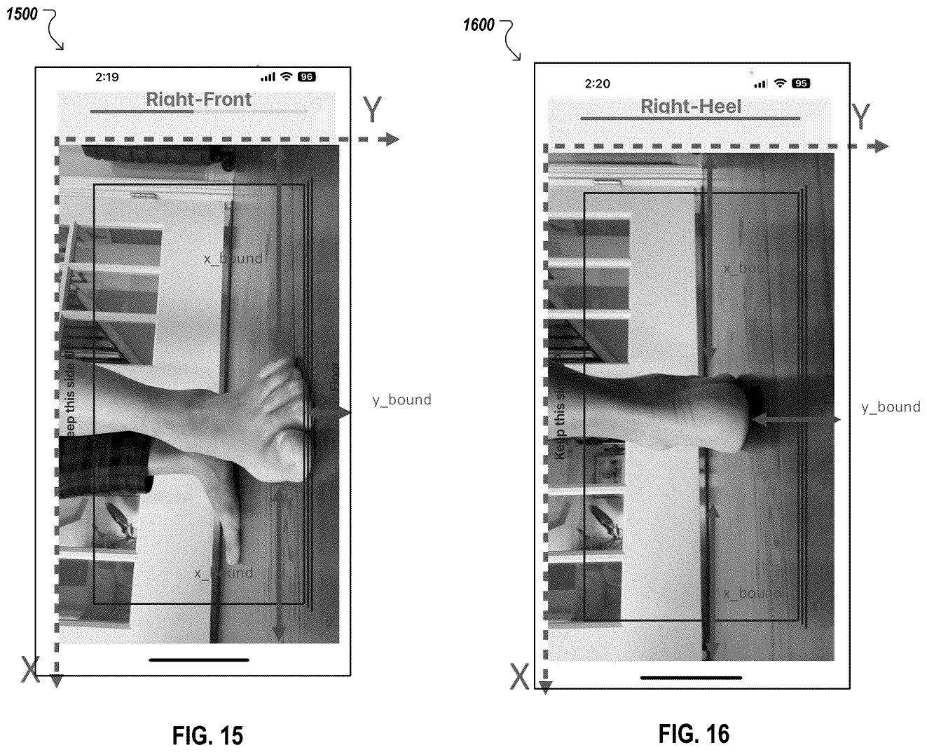

FIG. 15 depicts a scan 1500 of a front of a foot 301 and FIG. 16 depicts a scan 1600 of a back of a foot 301. For both scans 1500 and 1600, the user can place the scanning device 111 on its side on a surface, e.g., the floor, and align their foot 301 beside the scanning device 111. The example interactive user interfaces of these FIGS. show the position of the foot 301 with respect to the x-axis and the y-axis.

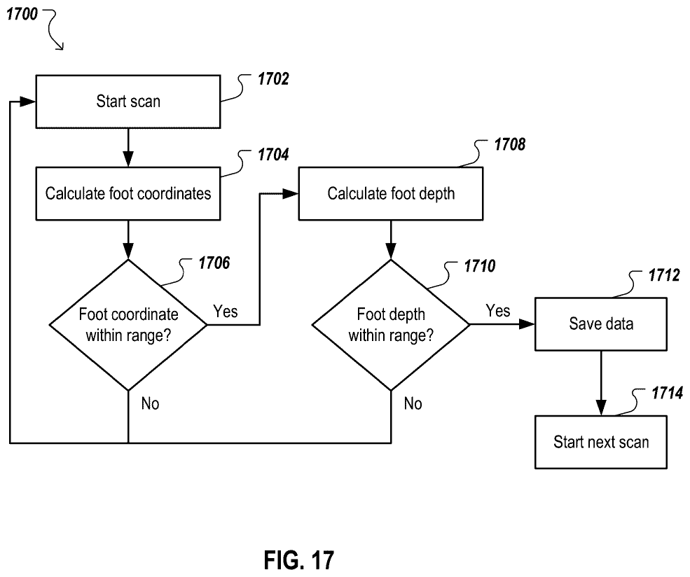

FIG. 17 is a flow chart of an example process 1700 for performing a quality check on a depth scan of a front or back of a foot. Operations of the process 1700 can be performed by a 3D reconstruction system, e.g., the 3D reconstruction system 110 of FIG. 1 or FIG. 2 or another data processing apparatus. The operations of the process 1700 can also be implemented as instructions stored on a computer readable medium, which can be non-transitory. Execution of the instructions, by one or more data processing apparatus, causes the one or more data processing apparatus to perform operations of the process 1700. For brevity, the process 1700 is described as being performed by a 3D reconstruction system.

The 3D reconstruction system starts the scan (1702). This can include obtaining image data for a scan, e.g., a scanning frame for the scan. This can also include generating or otherwise obtaining a depth map for the scan.

The 3D reconstruction system calculates foot coordinates for the foot (1704). These coordinates can include the x-bound and y-bound of the foot 301, as shown in FIGS. 15 and 16. The x-bound represents the boundary of the foot 301 along the x-axis and the y-bound represents the boundary of the foot 301 along the y-axis. For example, the x-bound can indicate the highest x-coordinate occupied by the foot in an image or depth map and the lowest x-coordinate occupied by the foot 301 in an image or depth map. Similarly, the y-bound can indicate the highest y-coordinate occupied by the foot in an image or depth map and the lowest y-coordinate occupied by the foot 301 in an image or depth map.

The 3D reconstruction system determines whether the foot coordinates are within a target range for the foot coordinates (1706). The target range can be defined by the target scan zone 1000. For example, the target range can be the x and y coordinates of a bounding box that defines the target scan zone.

If one or more of the foot coordinates are not within the target range for the foot coordinates, the process 1100 can return to (1702) at which another scan is obtained. In some implementations, the 3D reconstruction system can also provide instructions to the user to move the foot 301 into the proper position. For example, the 3D reconstruction system can output an audible voice prompt that includes the instructions. An example voice prompt may be “foot is out of the box.” Directional instructions can also be used, e.g., “move your foot to the left.” The use of audio is particularly advantageous since the user may not be holding the scanning device 111 and may not be able to view the screen of the scanning device 111.

If all foot coordinates are within the target range, the 3D reconstruction system calculates the foot depth (1708). The foot depth can represent the minimum distance between the foot 301 and the scanning device 111 (e.g., the lens of a camera or surface of the scanning device 111). The 3D reconstruction system can calculate the foot depth using the depth map, e.g., using the z-coordinate of each point on the foot 301 in the depth map.

The 3D reconstruction system determines whether the foot depth is within a target range for the foot depth (1710). The target range for the foot depth can define a minimum and maximum target distance from the scanning device 111 to the foot 301.

If the foot depth is not within the target range for the foot depth, the process 1100 can return to (1702) at which another scan is obtained. In some implementations, the 3D reconstruction system can also provide instructions to the user to move the foot 301 into the proper position. For example, the 3D reconstruction system can output an audible voice prompt that includes the instructions. An example voice prompt may be “too close” if the foot is too close to the scanning device 111 or “too far away” if the foot is too far from the scanning device 111.

If the foot depth is within the target range, the quality check is passed is passed successfully and the data (e.g., scanning frame, depth map, and/or calculated foot data) is stored (1712). If there are additional scans, the next scan can be initiated (1714).

In this example, the foot coordinate and foot depth are calculated and compared to target ranges in a particular order. However, this order can vary in different implementations. For example, the foot depth could be calculated and compared to a target range first in other examples.

FIGS. 18-24 depict example interactive user interfaces that guide a user through the process of scanning a foot, e.g., the user's foot or another person's foot, and show a reconstructed 3D point cloud of the foot. The interfaces can include graphical user interfaces that display various content and/or audible interfaces that provide voice instructions and/or receive voice commands. The interfaces can be generated and updated by a mobile application running on a user device, e.g., a user device that includes a 3D reconstruction system (e.g., the interactive scanning system 130 of FIGS. 1 and 2) or an interactive scanning system (e.g., the interactive scanning system 130 of FIG. 2). The interfaces can also be generated and updated by an application computing system, e.g., the application computing system 140 of FIG. 2, when some of the operations of the 3D reconstruction process are performed by an application computing system. For brevity, the interactive interfaces will be described as being generated by an interactive scanning system. Although the example interfaces are shown and described relative to foot objects, the same or similar user interfaces can be used for other types of objects.

FIG. 18 depicts an example interactive user interface 1800 for initiating a scan of a foot. The interface 1800 can be an initial interface shown to a user to start the process of scanning a foot 301. The interface 1800 includes initial instructions 1810 that instruct the user on how to prepare the user device and environment for the foot scanning. In this example, the first scan of the foot 301 is a scan of the bottom of the foot 301. However, the different scans of the foot 301 can be captured in any order.

The interface 1800 also includes a scan diagram 1820 that shows the user how to properly align the scanning device 111 with the bottom of the foot 301.

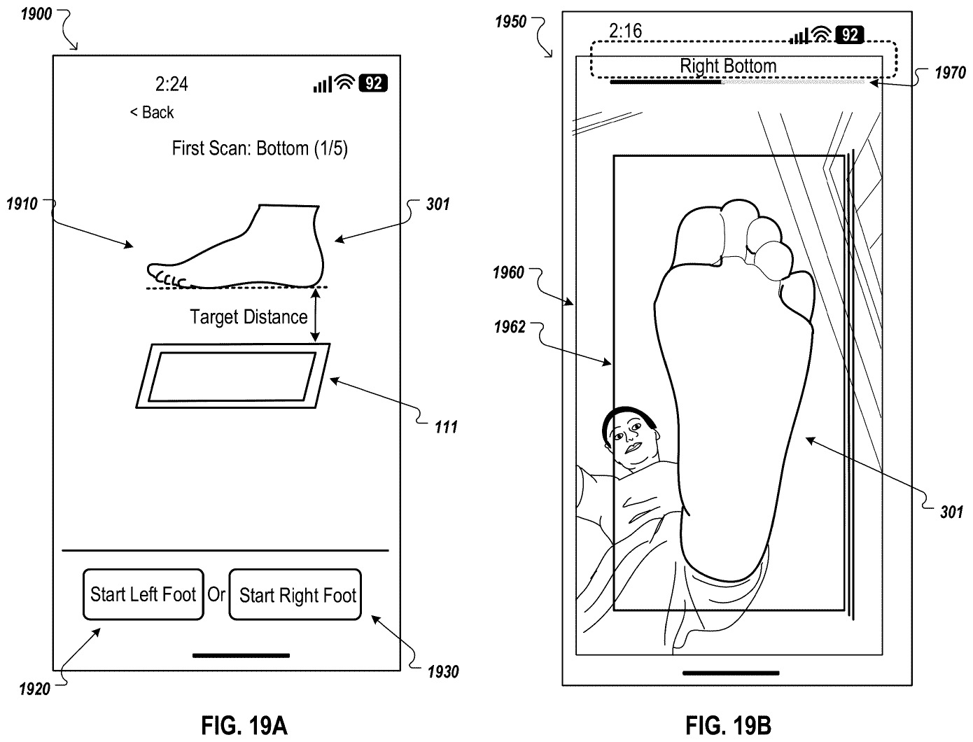

The interface 1800 also includes an interactive control 1830, e.g., a button or icon, that the user can interact with the initiate the scan of the bottom of the foot 301. For example, if the user interacts with the control 1830, e.g., by selecting the control 1830, the interactive scanning system can transition to the interactive user interface 1900 of FIG. 19A to initiate the scan of the bottom of the foot 301.

FIGS. 19A and 19B depict example interactive user interfaces 1900 and 1950 for capturing scans of a bottom of a foot 301. Referring to FIG. 19A, the interface 1900 includes a scan diagram 1910 that shows the user how to properly align the scanning device 111 with the bottom of the foot 301. The interface 1900 also includes interactive controls 1920 and 1930 that allow the user to select between the left foot and the right foot for the scan. User interaction with, e.g., selection of, the interactive control 1930 can cause the interactive scanning system to transition to the interface 1950 to obtain the scan of the bottom of the right foot. Similarly, user interaction with, e.g., selection of, the interactive control 1920 can cause the interactive scanning system to transition to the interface 1950 to obtain the scan of the bottom of the left foot.

Referring to FIG. 19B, the interface 1950 includes a scan view area 1960 that shows the current scene from the viewpoint of the scanning device 111. The interactive scanning system can display a target area guide 1962 that shows the user the target area for the bottom of the foot 301. The bottom of the foot 301 should be within the target area defined by the target area guide 1962 to produce a high-quality depth map. The target area guide 1962 assists the user in aligning the scanning device 111 with the bottom of the foot 301.

The interface 1950 also includes an animated progress bar 1970 that indicates a relative distance between the bottom of the foot 301 and the scanning device 111. The progress bar 1970 uses a visual indicator to show the distance. For example, the progress bar 1970 can use motion to show a bar of a first color extending along a bar of a second color to indicate the distance such that a longer bar of the first color represents a longer distance between the bottom of the foot 301 and the scanning device 111. Other types of progress or distance indicators can also be used.

The target area guide 1962 and the progress bar 1920 enable the scanning process to be performed faster and more efficiently by reducing the number of images captured, the number of depth maps generated, and the number of depth maps that are processed during the quality check. If the user's foot is outside the target area or a target range for the distance between the bottom of the foot 301 and the scanning device 111, the interactive scanning device 111 can generate a notification or alert. The notification or alert can include a voice guide with instructions to guide the user to move the foot 301 or scanning device 111 into the proper position. For example, if the foot 301 is outside the target area guide 1912, the interactive scanning system can trigger a voice prompt of “foot is out of the box” or “move your foot to the left.”

If a depth scan for the bottom of the foot passes the quality check, the interactive scanning system can automatically transition to the next scan. In this example, the next scan is a scan of the inner side of the foot 301.

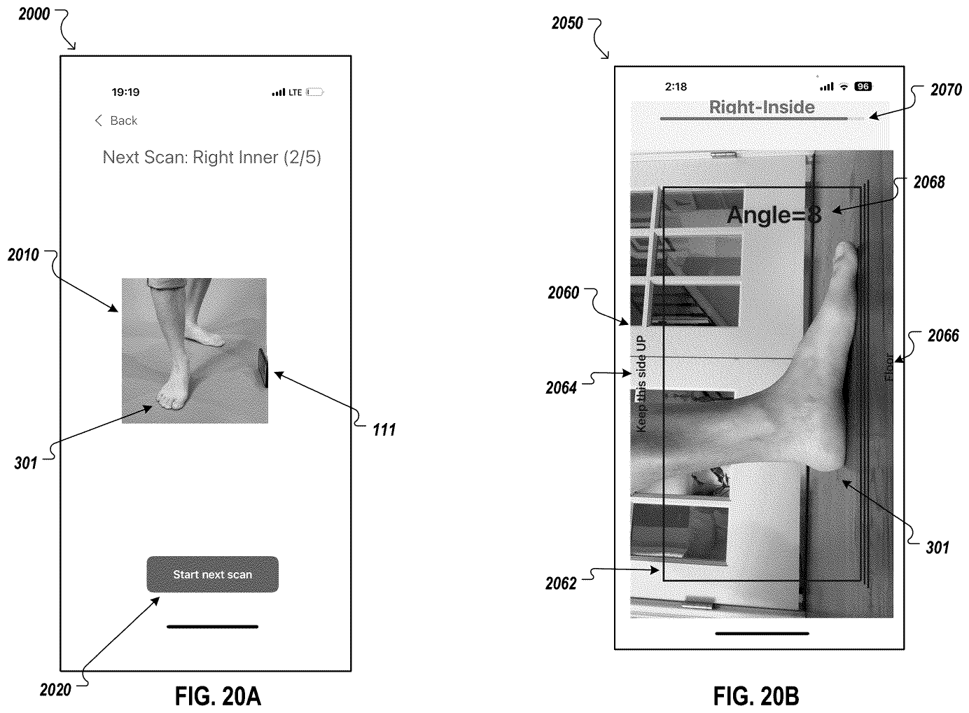

FIGS. 20A and 20B depict example interactive user interfaces 2000 and 2050 for capturing scans of an inner side of a foot 301. Referring to FIG. 20A, the interface 2000 includes a scan diagram 2010 that shows the user how to properly align the scanning device 111 with the inner side of the foot 301. The interface 2000 also includes an interactive control 2020 that allows the user to initiate the scan of the inner side of the foot 301. User interaction with, e.g., selection of, the interactive control 2020 can cause the interactive scanning system to transition to the interface 2050 to obtain the scan of the inner side of the foot 301.

Referring to FIG. 20B, the interface 2050 includes a scan view area 2060 that shows the current scene from the viewpoint of the scanning device 111. The interactive scanning system can display a target area guide 2062 that shows the user the target area for the inner side of the foot 301. The inner side of the foot 301 should be within the target area defined by the target area guide 2062 to produce a high-quality depth map. The target area guide 2062 assists the user in aligning the scanning device 111 with the inner side of the foot 301.

The interface 2050 also includes labels 2064 and 2066. The label 2064 provides instructions for the user to “keep this side up” and the label 2066 indicates the proper location for the floor relative to the scanning device 111. These labels 2064 and 2066 guides the user to put the scanning device 111 in the proper orientation, e.g., landscape-right: landscape mode with the top of the scanning device to the right, during side scans.

The interface 2050 also includes an angle indicator element 2068 that shows the angle between the inner side of the foot 301 and the scanning device. To generate high-quality depth maps of feet, this angle should be as close to zero as possible such that the inner side of the foot and the scanning device are parallel. If the angle is high, the details of the toe or the heel may be lost or inaccurate.

The interface 2050 also includes an animated progress bar 2070 that indicates a relative distance between the inner side of the foot 301 and the scanning device 111. Similar to the progress bar 1970, the progress bar 2070 uses a visual indicator to show the distance. Other types of progress or distance indicators can also be used.

The target area guide 2062, the progress bar 2070, the labels 2064 and 2066, and the angle indicator element 2068 enable the scanning process to be performed faster and more efficiently by reducing the number of images captured, the number of depth maps generated, and the number of depth maps that are processed during the quality check. If the user's foot is outside the target area or a target range for the distance between the inner side of the foot 301 and the scanning device 111, the interactive scanning device 111 can generate a notification or alert. The notification or alert can include a voice guide with instructions to guide the user to move the foot 301 or scanning device 111 into the proper position. For example, if the foot 301 is outside the target area guide 2062, the interactive scanning system can trigger a voice prompt of “foot is out of the box” or “move your foot to the forward.” In another example, if the angle between the inner side of the foot and the scanning device is too large, the interactive system can trigger a voice prompt of “angle too high” or “level the scanning device.”

If a depth scan for the inner side of the foot passes the quality check, the interactive scanning system can automatically transition to the next scan. In this example, the next scan is a scan of the outer side of the foot 301.

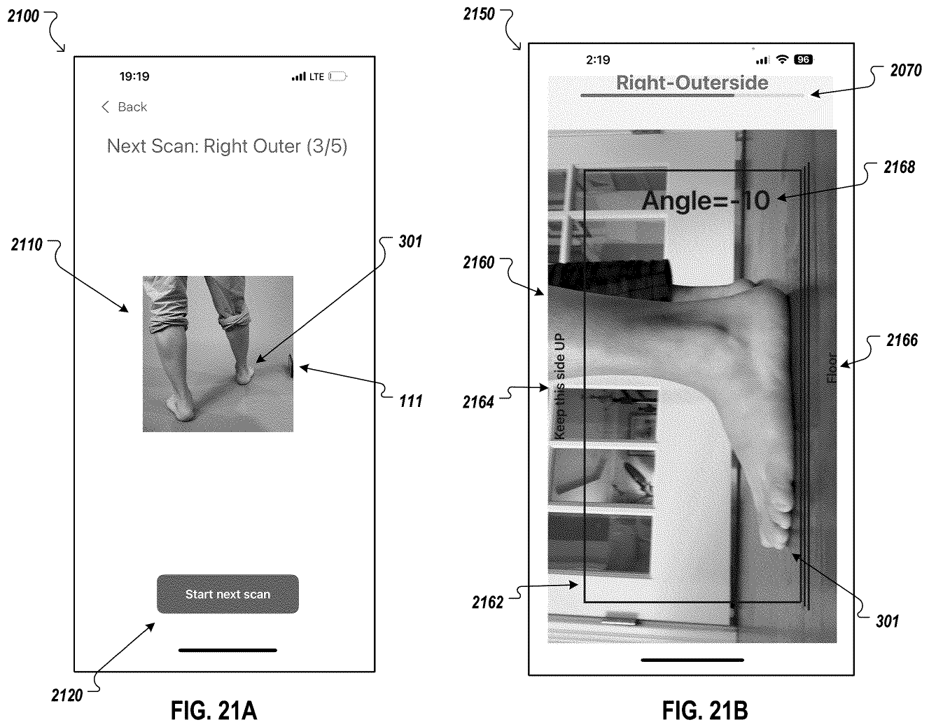

FIGS. 21A and 21B depict example interactive user interfaces 2100 and 2150 for capturing scans of an outer side of a foot. Referring to FIG. 21A, the interface 2100 is similar to the interface 2000 of FIG. 20A for capturing scans of the inner side of the foot and includes the same components, e.g., a scan diagram 2110 that shows the user how to properly align the scanning device 111 with the outer side of the foot 301 and an interactive control 2120 that allows the user to initiate the scan of the outer side of the foot 301. User interaction with, e.g., selection of, the interactive control 2120 can cause the interactive scanning system to transition to the interface 2150 to obtain the scan of the outer side of the foot 301.

Referring to FIG. 21B, the interface 2150 is also similar to the interface 2050 of FIG. 20B. For example, the interface 2150 includes a scan view area 2160, target area guide 2162, progress bar 2170, labels 2164 and 2166, and angle indicator element 2168, which can be the same as or similar to the scan view area 2060, target area guide 2062, progress bar 2070, labels 2064 and 2066, and angle indicator element 2068 of FIG. 20B. Thus, the same or similar interfaces can be used to obtain both the inner and outer foot scans.

If a depth scan for the outer side of the foot passes the quality check, the interactive scanning system can automatically transition to the next scan. In this example, the next scan is a scan of the front of the foot 301.

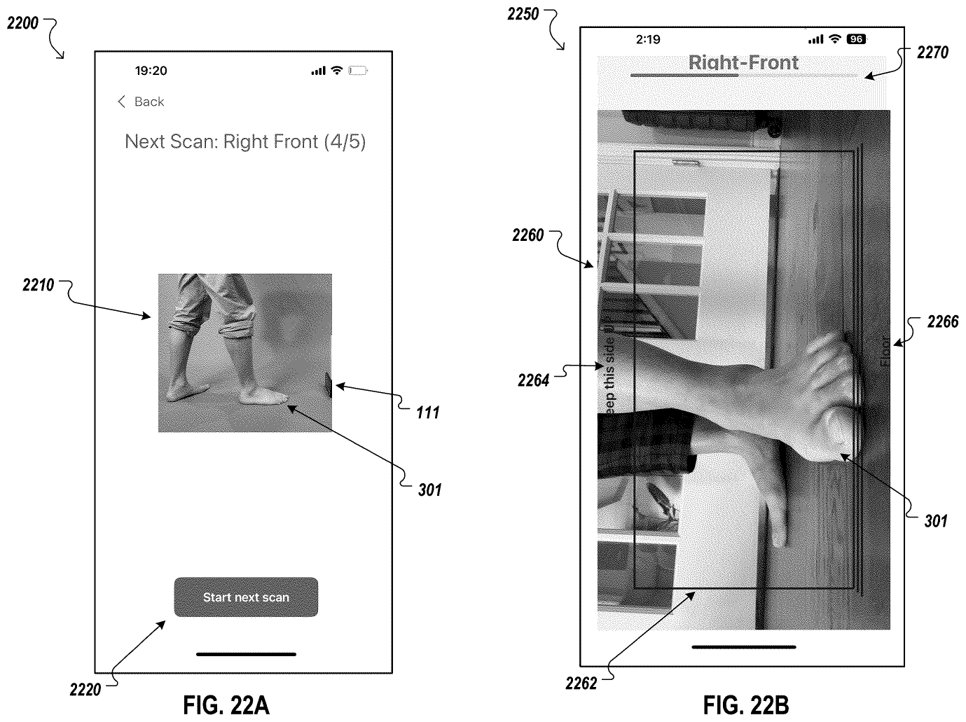

FIGS. 22A and 22B depict example interactive user interfaces 2200 and 2250 for capturing scans of a front of a foot. Referring to FIG. 22A, the interface 2200 includes a scan diagram 2210 that shows the user how to properly align the scanning device 111 with the front of the foot 301. The interface 2200 also includes an interactive control 2220 that allows the user to initiate the scan of the front of the foot 301. User interaction with, e.g., selection of, the interactive control 2220 can cause the interactive scanning system to transition to the interface 2250 to obtain the scan of the front of the foot 301.

Referring to FIG. 22B, the interface 2250 includes a scan view area 2060 that shows the current scene from the viewpoint of the scanning device 111. The interactive scanning system can display a target area guide 2262 that shows the user the target area for the front of the foot 301. The front of the foot 301 should be within the target area defined by the target area guide 2262 to produce a high-quality depth map. The target area guide 2262 assists the user in aligning the scanning device 111 with the front of the foot 301.

The interface 2250 also includes labels 2264 and 2266. The label 2264 provides instructions for the user to “keep this side up” and the label 2266 indicates the proper location for the floor relative to the scanning device 111. These labels 2264 and 2266 guides the user to put the scanning device 111 in the proper orientation, e.g., landscape-right: landscape mode with the top of the scanning device to the right, during side scans.

The interface 2250 also includes an animated progress bar 2270 that indicates a relative distance between the front of the foot 301 and the scanning device 111. Similar to the progress bar 1970, the progress bar 2270 uses a visual indicator to show the distance. Other types of progress or distance indicators can also be used.

The target area guide 2262, the progress bar 2270, and the labels 2264 and 2266 enable the scanning process to be performed faster and more efficiently by reducing the number of images captured, the number of depth maps generated, and the number of depth maps that are processed during the quality check. If the user's foot is outside the target area or a target range for the distance between the inner side of the foot 301 and the scanning device 111, the interactive scanning device 111 can generate a notification or alert. The notification or alert can include a voice guide with instructions to guide the user to move the foot 301 or scanning device 111 into the proper position. For example, if the foot 301 is outside the target area guide 2262, the interactive scanning system can trigger a voice prompt of “foot is out of the box” or “move your foot to the right.”

If a depth scan for the front of the foot passes the quality check, the interactive scanning system can automatically transition to the next scan. In this example, the next scan is a scan of the back of the foot 301.

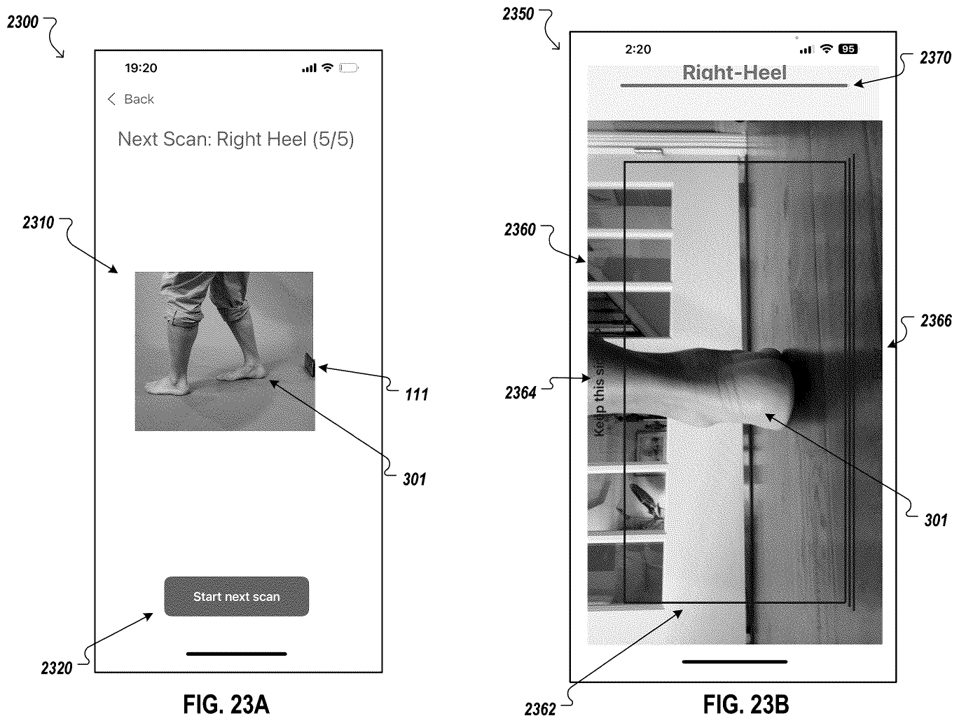

FIGS. 23A and 23B depict example interactive user interfaces 2300 and 2350 for capturing scans of a back of a foot. Referring to FIG. 23A, the interface 2300 is similar to the interface 2200 of FIG. 22A for capturing scans of the front of the foot and includes the same components, e.g., a scan diagram 2310 that shows the user how to properly align the scanning device 111 with the back of the foot 301 and an interactive control 2320 that allows the user to initiate the scan of the back of the foot 301. User interaction with, e.g., selection of, the interactive control 2320 can cause the interactive scanning system to transition to the interface 2350 to obtain the scan of the back of the foot 301.

Referring to FIG. 23B, the interface 2350 is also similar to the interface 2250 of FIG. 22B. For example, the interface 2350 includes a scan view area 2360, target area guide 2362, progress bar 2370, and labels 2364 and 2366, which can be the same as or similar to the scan view area 2260, target area guide 2262, progress bar 2270, and labels 2264 and 2266 of FIG. 22B. Thus, the same or similar interfaces can be used to obtain both the front and back foot scans.

If a depth scan for the back of the foot passes the quality check, the interactive scanning system can automatically transition to the next scan. In this example, the next scan is a scan of the top of the foot 301.

FIGS. 24A and 24B depict example interactive user interfaces 2400 and 2450 for capturing scans of a top of a foot. Referring to FIG. 24A, the interface 2400 includes a scan diagram 2410 that shows the user how to properly align the scanning device 111 with the top of the foot 301. The interface 2400 also includes an interactive control 2420 that allows the user to initiate the scan of the top of the foot 301. User interaction with, e.g., selection of, the interactive control 2420 can cause the interactive scanning system to transition to the interface 2450 to obtain the scan of the top of the foot 301.

Referring to FIG. 24B, the interface 2450 includes a scan view area 2460 that shows the current scene from the viewpoint of the scanning device 111. The interactive scanning system can display a target area guide 2462 that shows the user the target area for the top of the foot 301. The top of the foot 301 should be within the target area defined by the target area guide 2462 to produce a high-quality depth map. The target area guide 2462 assists the user in aligning the scanning device 111 with the top of the foot 301.

The interface 2450 also includes an animated progress bar 2470 that indicates a relative distance between the top of the foot 301 and the scanning device 111. The progress bar 2470 uses a visual indicator to show the distance. For example, the progress bar 2470 can use motion to show a bar of a first color extending along a bar of a second color to indicate the distance such that a longer bar of the first color represents a longer distance between the bottom of the foot 301 and the scanning device 111. Other types of progress or distance indicators can also be used.

The target area guide 2462 and the progress bar 2420 enable the scanning process to be performed faster and more efficiently by reducing the number of images captured, the number of depth maps generated, and the number of depth maps that are processed during the quality check. If the user's foot is outside the target area or a target range for the distance between the bottom of the foot 301 and the scanning device 111, the interactive scanning device 111 can generate a notification or alert. The notification or alert can include a voice guide with instructions to guide the user to move the foot 301 or scanning device 111 into the proper position. For example, if the foot 301 is outside the target area guide 2412, the interactive scanning system can trigger a voice prompt of “foot is out of the box” or “move your foot to the left.”

If a depth scan for the top of the foot passes the quality check, then high quality depth maps have been obtained for each view of the foot. The depth maps for each view of the foot can be used to generate a 3D reconstruction of the foot and/or measurements of parameters of the foot can be generated. If a scan of the other foot is desired, the user can return to the interface 1900 and start the scan process for the other foot.

FIG. 25 depicts an example interactive user interface 2500 that shows a reconstructed 3D point cloud 2520 of a foot 301. The example interface 2500 includes a point cloud viewing area 2510 in which the point cloud 2520 can be rotated so that the user can be view the point cloud 2520 from various perspectives. For example, the user can drag the point cloud 2520 in various directions to rotate the point cloud 2520 within the point cloud viewing area 2510. The interface 2500 also include interactive controls 2532 and 2534 that enable the user to switch between views of the point cloud 2520 for the left foot and the point cloud 2520 for the right foot.

FIG. 26 depicts an example interactive user interface 2600 that shows calculated parameters of a foot 301 using a 3D reconstruction of the foot 301. The example interface shows a calculated width 2610 of the foot 301, a calculated length 2620 of the foot 301, and a calculated instep height 2630 of the foot 301. These calculations can be made using the 3D reconstruction of the foot 301, as described above.

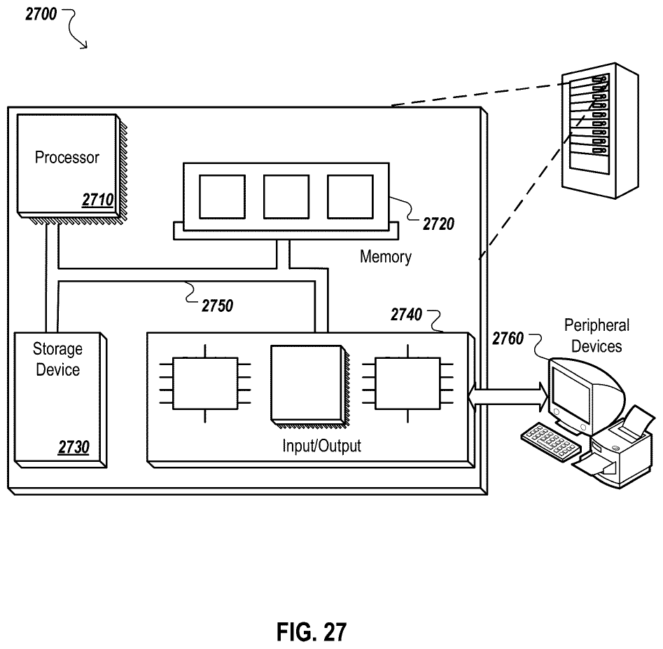

FIG. 27 is a block diagram of an example computer system 2700 that can be used to perform operations described above. The system 2700 includes a processor 2710, a memory 2720, a storage device 2730, and an input/output device 2740. Each of the components 2710, 2720, 2730, and 2740 can be interconnected, for example, using a system bus 2750. The processor 2710 is capable of processing instructions for execution within the system 2700. In one implementation, the processor 2710 is a single-threaded processor. In another implementation, the processor 2710 is a multi-threaded processor. The processor 2710 is capable of processing instructions stored in the memory 2720 or on the storage device 2730.

The memory 2720 stores information within the system 2700. In one implementation, the memory 2720 is a computer-readable medium. In one implementation, the memory 2720 is a volatile memory unit. In another implementation, the memory 2720 is a non-volatile memory unit.

The storage device 2730 is capable of providing mass storage for the system 2700. In one implementation, the storage device 2730 is a computer-readable medium. In various different implementations, the storage device 2730 can include, for example, a hard disk device, an optical disk device, a storage device that is shared over a network by multiple computing devices (e.g., a cloud storage device), or some other large capacity storage device.

The input/output device 2740 provides input/output operations for the system 2700. In one implementation, the input/output device 2740 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 2760. Other implementations, however, can also be used, such as mobile computing devices, mobile communication devices, set-top box television client devices, etc.

Although an example processing system has been described in FIG. 27, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method of generating a three-dimensional (3D) reconstruction of an object, the method comprising:
obtaining, for each view in a set of views of the object, a quality depth map that represents location coordinates of points on the object from the view, wherein the obtaining comprises, for each view,
obtaining image data representing one or more images of the object from the view,
obtaining one or more depth maps that represent location coordinates of points on the object, and
identifying, as the quality depth map, a given depth map that satisfies one or more quality checks;
generating the 3D reconstruction of the object using the quality depth map for each view in the set of views; and
outputting the 3D representation of the object.

2. The method of claim 1, wherein outputting the 3D representation of the object comprises displaying the 3D representation of the object.

3. The method of claim 1, wherein:
the object comprises a foot; and
outputting the 3D representation of the model comprises sending the 3D representation of the model to an additive manufacturing device configured to generate a form of the foot using the 3D representation of the object.

4. The method of claim 1, wherein the image data comprises a digital image of the object and depth data that indicates, for each pixel in the digital image, a distance between a camera that captured the digital image and the object depicted by the pixel.

5. The method of claim 1, wherein obtaining the image data comprises obtaining the image data from two or more cameras having different optical axes.

6. The method of claim 1, wherein obtaining the image data comprises obtaining the image data from a depth sensor and/or a LiDAR camera.

7. The method of claim 1, wherein identifying, as the quality depth map, a given depth map that satisfies one or more quality checks comprises performing the one or more quality checks using the given depth map.

8. The method of claim 7, wherein performing the one or more quality checks comprises determining whether a distance between the object and a scanning device that captured at least a portion of the image data is within a target range.

9. The method of claim 7, wherein performing the one or more quality checks comprises determining whether an angle between the object and a scanning device is within a target range.

10. The method of claim 7, wherein performing the one or more quality checks comprises determining whether the object is located within a bounding box.

11. The method of claim 7, wherein performing the one or more quality checks comprises:
determining that the depth map did not pass a quality check; and
in response to determining that the depth map did not pass the quality check, providing a voice guide that audibly instructs a user to realign the object with a scanning device.

12. The method of claim 1, wherein the object comprises an asymmetric object.

13. The method of claim 1, comprising analyzing the 3D reconstruction of the object to identify dimensions and/or geometries of the object.

14. The method of claim 1, comprising presenting an interactive user interface that depicts a scan diagram that shows a user how to properly align the scanning device with the object.

15. The method of claim 1, comprising guiding the user through a sequence of interactive user interfaces to capture image data for each view, wherein the sequence of user interfaces comprises, for each view, an interactive user interface that depicts a scan diagram for the view, wherein the scan diagram for each view shows a user how to properly align the scanning device with the object for that view.

16. The method of claim 15, wherein each scan diagram depicts a target distance or target distance range from which the scanning device should be spaced from the object.

17. The method of claim 15, comprising, for each view, performing the one or more quality checks on each of one or more depth maps obtained using the user interface for the view to identify the given depth map that satisfies the one or more quality checks for the view.

18. The method of claim 17, wherein generating the 3D reconstruction of the object using the quality depth map for each view in the set of views comprises generating the 3D reconstruction in response to identifying the quality depth map for each view.

19. The method of claim 1, wherein obtaining the one or more depth maps that represent location coordinates of points on the object comprises obtaining a depth map using optical image data from the one or more images of the object and depth data obtained from a depth sensor.

20. The method of claim 1, comprising executing multiple processing threads, wherein:
a first processing thread of the multiple processing threads is executed to obtain the quality depth map for each view; and
a second processing thread of the multiple processing threads is executed to generate the 3D reconstruction of the object.

21. A system comprising:
one or more processors; and
one or more storage devices storing instructions that, when executed by the one or more processors, cause the one or more processors to perform operations comprising:
obtaining, for each view in a set of views of an object, a quality depth map that represents location coordinates of points on the object from the view, wherein the obtaining comprises, for each view,
obtaining image data representing one or more images of the object from the view,
obtaining one or more depth maps that represent location coordinates of points on the object, and
identifying, as the quality depth map, a given depth map that satisfies one or more quality checks;
generating a 3D reconstruction of the object using the quality depth map for each view in the set of views; and
outputting the 3D representation of the object.

22. A non-transitory computer readable storage medium carrying instructions that, when executed by one or more processors, cause the one or more processors to perform operations comprising:
obtaining, for each view in a set of views of an object, a quality depth map that represents location coordinates of points on the object from the view, wherein the obtaining comprises, for each view,
obtaining image data representing one or more images of the object from the view,
obtaining one or more depth maps that represent location coordinates of points on the object, and
identifying, as the quality depth map, a given depth map that satisfies one or more quality checks;
generating a 3D reconstruction of the object using the quality depth map for each view in the set of views; and
outputting the 3D representation of the object.
